(19) United States
(12) Patent Application Publication
(10) Pub. No.: US 2014/0030487 A1
(43) Pub. Date: Jan. 30, 2014

(54) Controlled Material Interface Transformation

(71) Applicant: Massachusetts Institute of Technology, Cambridge, MA (US)

(72) Inventors: Mary Cunningham Boyce, Winchester, MA (US); Yaning Li, Cambridge, MA (US); Narges Kaynia, Cambridge, MA (US); Stephan Rudykh, Newton, MA (US)

(73) Assignee: Massachusetts Institute of Technology, Cambridge, MA (US)

(21) Appl. No.: 13/953,195

(22) Filed: Jul. 29, 2013

Related U.S. Application Data
(60) Provisional application No. 61/676,402, filed on Jul. 27, 2012.

(51) Int. Cl. B29C 55/02; B32B 3/28

(52) U.S. Cl. CPC B29C 55/023; B32B 3/28
USPC 428/161; 264/229

(57) ABSTRACT

One aspect of the invention relates to materials and devices with interface layers with geometries which transform upon the direct or indirect application of load or displacement. The interface layers may transform from straight or flat shapes to wavy or hierarchically wavy morphologies or the waviness can be altered by load or displacement to tailor wavelength and amplitude of the interface geometry. Methods of predictably altering the interfacial morphology are also described. The ability to control material interface transformation can be used to regulate and to tune mechanical, chemical, thermal, swelling, photonic, phononic, electrical and optical functions, including color and reflectivity of the material.

### RELATED APPLICATIONS

This application claims the benefit of priority to U.S. Provisional Patent Application Ser. No. 61/676,402, filed Jul. 27, 2012, the contents of which are hereby incorporated by reference.

### GOVERNMENT SUPPORT

This invention was made with government support under grant numbers W911NF-07-D-004 Awarded by the Army Research Office, and DMR-0819762 awarded by the National Science Foundation. The government has certain rights in the invention.

### BACKGROUND OF THE INVENTION

In natural systems many layered and cellular structured composites possess wrinkled interfacial layers that help to regulate mechanical, chemical, acoustic, thermal, electrical and optical functions. In fact, undulating interfacial layers are found throughout nature. Some examples include the wavy thin layer of quartz with periodic folds seen in the geological strata-quartz vein (FIG. 1a) resulting from various geological forces, the wavy reflective plates of the silvery reflectors around the eyes of squid (L. Pealeii) (FIG. 1b), wrinkling observed in the lamellae that is embedded in collagen and smooth muscles in arterial walls, as well as the wavy inter-cellular boundaries of epidermis cells of the plant Arabidopsis thaliana (FIG. 1c). These undulation patterns in natural systems govern key aspects of their mechanical, chemical, acoustic, thermal, electrical, and optical functions, and also serve to reveal underlying physiological mechanisms relevant to diagnosis of disease.

Long wavy reflective plates (more than 10 mm) with varying thicknesses (ranging from 80 to 130 nm), orientation and irregular spacing are found in the Iridophore cells around the eyes of L. Pealeii squid, as shown in FIG. 1b. The wavy geometry of the reflective plates has been found to facilitate broadband reflectance, and to be responsible for the observable silvery iridescence. Tailored stacking of wavy layers provides bio-inspired multi-layer reflectors to achieve different optical functions.

The arterial wall includes many wavy elastica embedded in smooth muscle. The degree of elastica undulation in the distal section of the right coronary artery was found to be significantly greater in persons with coronary artery disease compared to that found in the disease-free control group. The spasm of the distal part of the right coronary artery may have caused local ischemia in the central parts of the cardiac conducting system, precipitating a lethal arrhythmia. Hence, the wavy structure can serve as a diagnostic signature, and understanding the mechanism governing the waveform can provide clues to other underlying structural, chemical and mechanical changes.

Plant epidermis is an intermediate layer of cells between the outmost cuticle layer and the ground tissue. The inter-cellular boundaries exhibit a wavy undulating pattern, such as the epidermis cells of Arabidopsis thaliana, as shown in FIG. 1c. Arabidopsis was the first plant genome to be sequenced, and is a popular model organism in plant biology and genetics for understanding the molecular biology of many plant traits, including flower development, light sensing and local adaptation. The plant epidermis cell is an important architectural control element that regulates the growth properties of underlying tissues. It is widely taken as an axiom in botany that during the growth process the plant cell wall constrains the rate of cell expansion and limits the final size of the cell. The mechanical properties determine the volume and shape changes of plant cells; however, experimental data directly supporting this axiom is absent.

There exists a need for analytical, numerical, and experimental mechanical models that identify underlying mechanisms for the formation of undulating interfacial structures observed in nature. In certain embodiments, the proposed models will serve as quantitative tools to develop design guidelines for reversible and tunable, multi-functional layered and cellular structured composites.

### SUMMARY OF THE INVENTION

In certain embodiments, the invention relates to a method, comprising the steps of:
providing a first material and a second material;
contacting the first material with the second material to form a composite material with a material interface;
applying a first force to the composite material, wherein the first force is calculated to produce a desired transformation in the morphology of the material interface, and the first force produces the desired transformation in the morphology of the material interface, thereby forming a transformed composite material.

In certain embodiments, the invention relates to any one of the aforementioned methods, wherein the first force is stretch or strain.

In certain embodiments, the invention relates to any one of the aforementioned methods, wherein the force is stretch or strain; and the force is applied substantially in-plane with the material interface.

In certain embodiments, the invention relates to any one of the aforementioned methods, wherein the first force is applied directly or indirectly to the composite material.

In certain embodiments, the invention relates to any one of the aforementioned methods, wherein the material interface is transformed from being substantially straight to having a wavy pattern.

In certain embodiments, the invention relates to a transformed composite material made by any one of the aforementioned methods.

In certain embodiments, the invention relates to an article comprising any one of the aforementioned transformed composite materials.

### BRIEF DESCRIPTION OF THE FIGURES

FIG. 1 depicts schematics showing examples of periodic structural materials with multiple phases and various morphologies (where d is the distance between layers, and t is the thickness of the interfacial layer): (a) layered structure, (b) cellular structures, and (c) structures with systematic and random inclusions of one phase embedded in another phase (note that one phase may be air).

FIG. 2 depicts schematics of controlled reversible wrinkling material interfaces in composites with (a) a single interfacial layer (different colors represent different materials), and (b) multi-layers (by tailoring the thickness of the interfacial layers and/or the mechanical properties of the materials)

FIG. 3 depicts schematics of controlled reversible wrinkling material interfaces in cellular composites of different morphologies: (a) rectangular, (b) brick, (c) diamond, and (d) hexagonal, and (e) two types of patterns for all cellular composites (the hexagonal structure is shown as an example): Type I shows local wrinkling of individual cells; Type II shows macro floral pattern with single cell pattern repeating or alternating in the directions of symmetric axes.

FIG. 4 depicts schematics of the reversible transformation of interface morphology in (a) materials with inclusions, and (b) porous materials.

FIG. 5 depicts schematics of the reversible transformation of an interface into higher order waveforms in (a) layered materials, (b) materials with inclusions, and (c) porous materials.

FIG. 6 depicts an example of layered composites with reversible acoustic properties upon wrinkling: (a) switchable phononic bandgaps generated in multi-layer composites due to wrinkling pattern, and (b) direction-dependent bandgaps for wrinkled layered composites.

FIG. 7 depicts examples of single- or multiple-layered composites in nature: (a) quartz veins from Porthleven, Cornwall, England, (b) electron micrograph of silvery reflectors around the eyes of squid (L. Pealeii) in cross section, showing wavy arrangement of reflective plates, and (c) inter-cellular undulation patterns of plant epidermis cells of Arabidopsis thaliana leaf after germination (DAG: days after germination).

FIG. 8 depicts schematics of a 2D mechanical model (with periodic boundaries) used to study the elastic instability of an infinite long layer embedded in two different compliant matrix materials on both sides: (a) dimensions, coordinates, and material properties, (b) external and internal loads, and (c) instability mode and characteristics including critical stress/strain and the critical wavelength.

FIG. 9 depicts (a) internal and external loads on a multi-layer composite, and (b) free body diagrams of a wrinkled interfacial layer under those loads.

FIG. 10 depicts the results of finite element simulations and mechanical tests for the dilute cases: (a) finite element results of the eigen-modes for various stiffness ratios of the two phases (‘2X’ and ‘5X’ means the deformation is amplified two and five times, respectively. This meaning is used for all the drawings); (b) comparison of the analytical (Eqs. 3) and finite element results of critical strain vs. stiffness ratio; (c) comparison of the analytical (Eqs. 3) and finite element results of non-dimensional half wrinkling wave length vs. stiffness ratio; and (d) experimental results on the wrinkling of a single interfacial layer.

FIG. 11 depicts (a) finite element results of the wrinkled interfacial layers embedded in two dissimilar phases (‘2X’ and ‘5X’ means the deformation is amplified two and five times, respectively); (b) comparison of the analytical (Eqs. 4) and finite element results of critical strain vs. stiffness ratio of the two matrix mediums (the symbols of ‘◯’, ‘▴’, ‘♦’, ‘▪’ and ‘’ represent E02E01=0, 0.25, 0.5, 0.75, and 1, respectively); (c) comparison of the analytical (Eqs. 4) and finite element results of non-dimensional half wrinkling wavelength vs. stiffness ratio of the two matrix mediums.

FIG. 12 depicts mode transition mechanisms for multi-layered composites from a dilute case to a concentrated case: (a) eigenmodes of layers with different distance-to-thickness ratio and stiffness ratios; (b) normal and shear stress contours for three selected cases (contained within boxes with partial dashed borders) showing the transition from wrinkling to global longwave instability.

FIG. 13 depicts mode transition for multi-layered composites: (a) phase diagram indicating the condition for mode transition (solid lines represent Eqs.(3), dashed lines represent Eq. (9); solid symbols represent the FE results of global modes, and the hollow symbols represent the FE results of wrinkling modes; depicted are lines representing E₁/E₀-100, 500, and 1000, respectively), (b) critical distance-to-thickness ratio between layers of mode transition for different stiffness ratio of the two phases (the solid line is Eq. (10)).

FIG. 14 depicts experimental results from the wrinkling of two examples of a multiple-layer structure.

FIG. 15 depicts a comparison of the present analytical model and the numerical results of hexagonal cellular composite: (a) the RVE (H=30 μm), (b) eigenvalues, and (c) eigenmodes from FE simulations for various stiffness ratio and thickness ratio of the embedded hexagonal network model (the circular, diamond, square and star markers represent the cases of t=0.5, 1, 2, and 4 μm, respectively).

FIG. 16 depicts a comparison of the present analytical model and the numerical results of diamond-shaped cellular composites: (a) the RVE (H=30 μm), (b) eigenvalues and (c) eigenmodes from FE simulations for various stiffness ratio and thickness ratio of the embedded diamond-shaped network model (the circular, diamond, square and star markers represent the cases of t=0.5, 1, 2, and 4 μm, respectively).

FIG. 17 depicts (a) a summary of the two types of undulation patterns from FE simulations, (b) undulation pattern of epidermis cells of Arabidopsis thaliana, with guard cells as a disturbance (top), and the details of mixed type I and type II cell pattern around the guard cell (bottom).

FIG. 18 depicts a study of cell shape effects: (a) eigenmodes of square cells with corner and mid junctions; (b) critical strain for various shapes when the aspect ratio is the same; and (c) influence of length aspect ratio of cells on the critical undulation strain.

FIG. 19 depicts patterns of plant epidermis cells in nature: (a) visualization of epidermis cells of Arabidopsis thaliana at different time points after germination (bar: 100 μm; DAG: days after germination), and (b) SEM micrographs showing undulation pattern of cell boundaries.

FIG. 20 depicts a schematic of the mechanical model for cell wall wrinkling (beam embedded in elastic matrix).

FIG. 21 depicts a comparison of the results of analytical derivation and the finite element simulations: (a) finite element simulation results of the undulation patterns for various stiffness ratios, and (b) nondimensional wavelength vs. stiffness ratio.

FIG. 22 depicts a comparison of the results of a simulation of the undulation pattern of the finite element hexagonal epidermis cell model (t=1 μm) for various cell wall stiffness.

FIG. 23 depicts a schematic representation of the direct lattice of a periodic material and its first Brillouin zone of the reciprocal lattice.

FIG. 24 depicts a schematic representation of a periodic layered material, and the corresponding representative volume element.

FIG. 25 depicts a schematic representation of wave propagation in layered media.

FIG. 26 depicts a dispersion diagram of the infinity homogeneous Gent material deformed at λ=1.2. Schematic representations of the direct lattice of a periodic material and its first Brillouin zone of the reciprocal lattice together with the path M-Γ-X-M are presented at the top.

FIG. 27 depicts the dispersion diagram of the layered composite with volume fraction of the stiff phase c⁽ⁱ⁾=0:02, μ⁽ⁱ⁾/μ^{(m)}=100, ρ⁽ⁱ⁾/ρ^{(m)}=5. The left bottom diagram represents the response of the undeformed medium and the right bottom is for the composite subjected to compression λ=0:95. Schematic representation of the direct lattice of a periodic material and its first Brillouin zone of the reciprocal lattice together with the path K-Γ-X-M-K are presented at the top.

FIG. 28 depicts stress-strain behavior of a layered composite and onset of bifurcations. The stiffness ratio of the phases is μ⁽ⁱ⁾/μ^{(m)}=100, and the volume fraction of the stiff inclusion is C⁽ⁱ⁾=0:01.

FIG. 29 depicts a dispersion diagram of the layered composite with Gent phases in the undeformed state, and deformed at λ=0:8.

FIG. 30 depicts dispersion diagrams of the material with Gold-Matrix wrinkled interfaces.

FIG. 31 depicts a dispersion diagram of the periodic structure with two different wrinkled interfaces. The composite is subjected to tension to λ=1.2.

FIG. 32 depicts experimental results showing the onset and development of the wrinkling of a single interfacial layer embedded in softer matrix made of TangoPlus (E₀=0.9 MPa): (a) Specimen 1 (row 1) with interface thickness t₀=0.5 mm made of Digital Material (E₁=18 MPa), Specimen 2 (row 2) with t₀=1 mm made of Digital Material, Specimen 3 (row 3) with t₀=0.5 mm made of VeroWhite material (E₁=1200 MPa), and Specimen 4 (row 4) with t₀=1 mm made of VeroWhite material.

FIG. 33 depicts results of mechanical experiments of the formation and development of the wrinkling of multi-layered composites: Specimen 1 (row 1) E₁/E₀=20 and d/t=20; Specimen 2 (row 2) E₁/E₀=20 and d/t=6; and Specimen 3 (row 3) E₁/E₀=1300 and d/t=20.

FIG. 34 depicts a predictive instability transition envelope showing the transition from wrinkling to long wave mode as a function of E₁/E₀ and d/t: comparison of the results of analytical prediction (solid line Eq. 6), Bloch wave analysis (dash line with error bars), FE simulations (hollow symbols), and mechanical experiments (solid symbols) for multi-layered composites.

FIG. 35 depicts an experimental setup of a single interfacial layer specimen with dimension definitions. The transparent fixture prevents deformation in the z-direction, assuring plane strain conditions.

### DETAILED DESCRIPTION OF THE INVENTION

### Overview

In certain embodiments, the invention relates to materials and devices with interface layers with geometries which transform upon the direct or indirect application of load or displacement. In certain embodiments, the interface layers can transform from straight or flat shapes to wavy and/or hierarchically wavy morphologies, and/or the waviness can be altered by load or displacement to tailor wavelength and amplitude of the interface geometry. In certain embodiments, interfacial morphology can be tuned precisely from simple geometries to very sophisticated and complex geometries. The ability to control material interface transformation can be used to regulate and to tune mechanical, chemical, thermal, swelling, photonic, phononic, electrical and optical functions, including color and reflectivity of the material. In certain embodiments, the undulating pattern of the interface governs the mechanical integrity of the interface as well as the mechanical and multifunctional performance of the complete micro or nano-structure or device. In certain embodiments, the interface structure also governs other attributes of functions, including overall thermal, chemical and swelling responses as well as enabling tenability of wave propagation phenomenon (e.g., phononic or photonic). In certain embodiments, for the case of elastomeric materials, the interface transformations and associated changes in properties and attributes are reversible upon removal of load and/or deformation. In certain embodiments, for the case of elastic-plastic materials, the changes can be permanent, permitting fabrication of complex interface topologies. In certain embodiments, the invention provides design principles to tailor mechanical/stimuli responsive hybrid multi-layered materials or devices, cellular structured materials or devices, materials, and devices for reversible multi-functional usage.

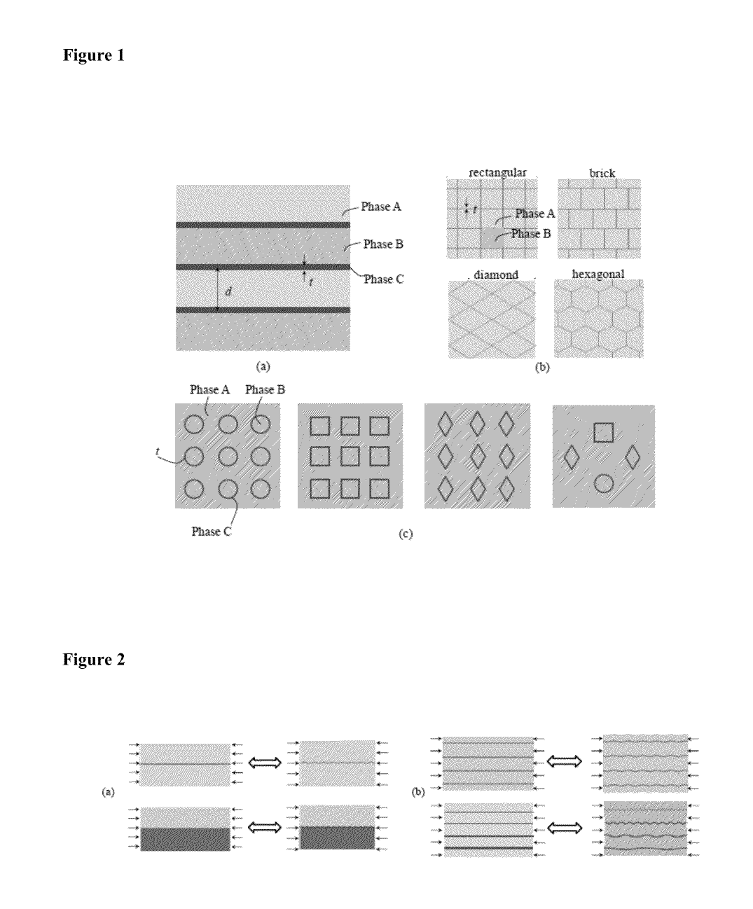

In certain embodiments, the invention relates to methods of controlling the interface morphology in materials and in devices via direct or indirect load or deformation-induced transformations. The interface layers can transform from straight or flat shapes to wavy and/or hierarchically wavy morphologies and/or the waviness can be altered by load or displacement to tailor wavelength and amplitude of the interface geometry. With this method, interfacial morphology can be tuned precisely from simple geometries to sophisticated and complex geometries. A method for estimating or predicting these interface transformations is also presented; in certain embodiments, this provides the ability to design and tune interface morphologies and transformations. In certain embodiments, the material interfaces include the interfacial layers between two same/different materials, such as those in layered composites (FIG. 1a), cellular composites (FIG. 1b), and other structures with multiple phases such as inclusions of one phase embedded in another phase with a separating interface layer (FIG. 1c).

In certain embodiments, the macroscopic stress and strain to control the morphology transformation can be generated in any of a large variety of ways, including mechanical far field or local loads, constrained swelling due to different stimuli (pH, humidity, light, temperature, electricity etc.), thermal expansion, and phase transformation.

In certain embodiments, for layered materials, the interfacial layer will wrinkle upon macroscopic compressive stress or strain along the direction of the layer. The wrinkling pattern can be tailored by varying the material compositions of the layers and the interfaces (FIG. 2a), the thicknesses of the interfacial layers (FIGS. 2a and 2b), and the distance between layers (FIG. 2b). The wrinkled topologies can be one-directional or two-directional depending upon the loading conditions.

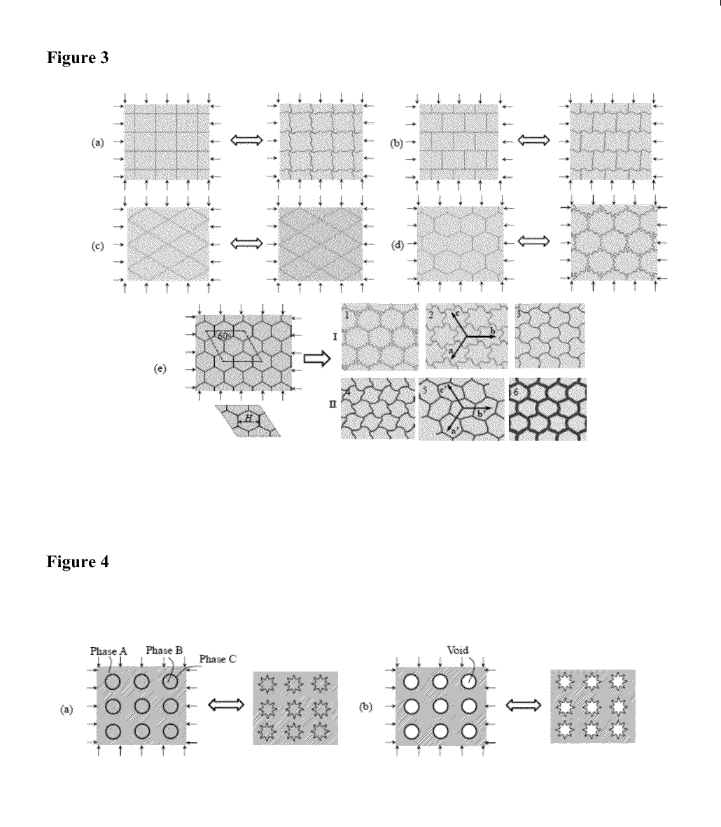

In certain embodiments, for cellular composites the interfacial wrinkling pattern can be tailored via material composition, the thickness of the interfacial layer as well as the shape of the cells. Examples of transformation of cellular interfacial wrinkling patterns of cellular composites with different cell shapes are shown in FIG. 3. The morphologies of the cellular composites include but are not limited to rectangular (FIG. 3a), brick (FIG. 3b), diamond (FIG. 3c) and hexagonal (FIG. 3d) shapes. Furthermore, two types of patterns (Type I and Type II) can be obtained based on the composition and thickness of the interfacial layer of the materials, as shown in FIG. 3e.

In certain embodiments, for structured materials containing inclusions of different phases wrinkling patterns can be tuned via tailoring the material composition, the thickness of the interfacial layer, and the geometry of the inclusions. FIG. 1c shows examples of various inclusion morphologies, and FIG. 4 demonstrates the wrinkling pattern for materials with circular shaped inclusions (FIG. 4a) and circular pores (FIG. 4b) coated with a thin interfacial layer.

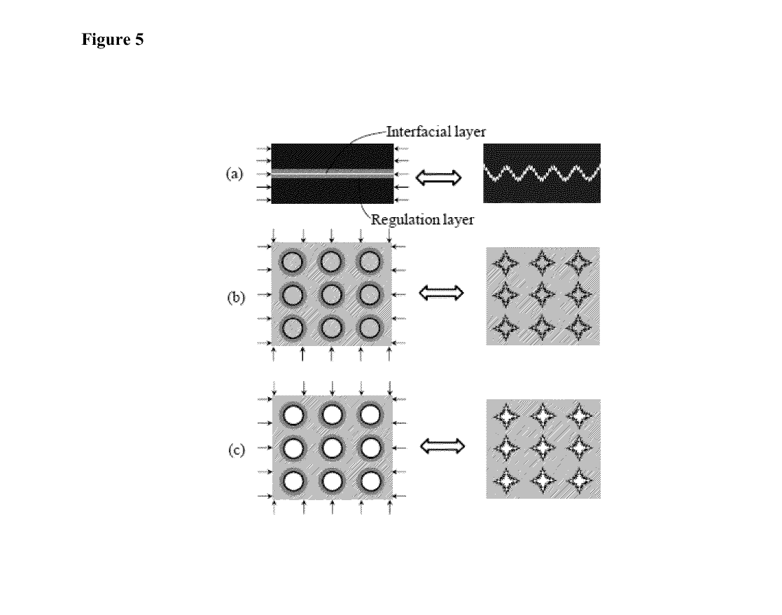

In addition, by introducing a regulation layer around the interfacial layer, in certain embodiments, more sophisticated wrinkling patterns can be obtained (FIG. 5). For all the geometric cases mentioned above, the interfacial layer can be tuned to give a higher order waveform via tailoring the material properties and thickness of the regulation layer and the interfacial layer. Examples of higher order wavy pattern transformation in layered materials (FIG. 5a), materials with inclusions (FIG. 5b) and porous materials (FIG. 5c) are shown schematically in FIG. 5.

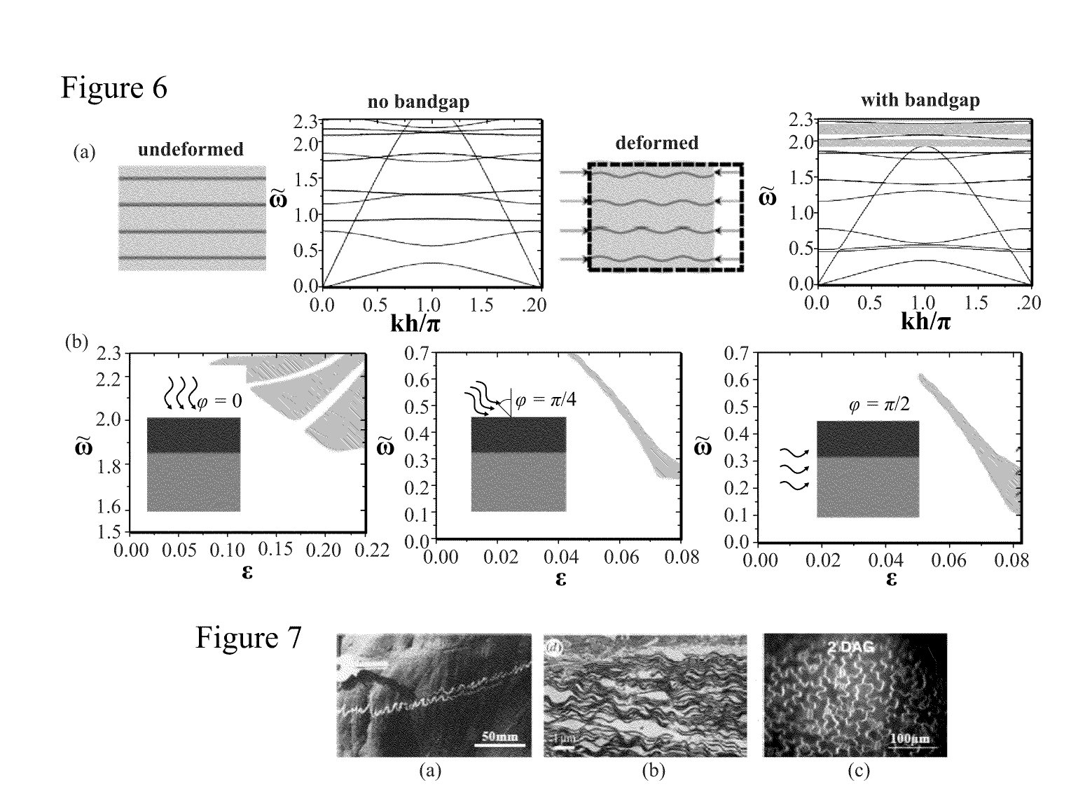

In certain embodiments, if the materials are elastomeric then removal of the critical macroscopic stress and strain results in the wavy pattern being fully recovered, whereas the wavy pattern is retained when the materials are elasto-plastic. Different wrinkling patterns lead to different mechanical, chemical, thermal, photonic, phononic, electrical and optical properties and functions of the material. Hence, these attributes are all switchable via the proposed method. In the case of wave propagation (photonic and phononic), the reversible wrinkling deformation can trigger the related properties, for example, creating bandgaps (FIG. 6).

In certain embodiments, the wavy pattern, including the wavelength, shape and amplitude, can be controlled precisely by tuning the interfacial layer thickness and the material compositions.

In certain embodiments, the invention relates to analytical and finite element models for exploring underlying mechanisms of the formation of the undulation pattern of the inter-cellular boundaries of plant epidermis cells during growth. The wave-length and the critical compressive stress of the undulation patterns are derived as functions of the geometry (thickness of the cell wall) and material properties (Young's moduli and Poisson's ratios) of the cell wall and internal gel-like pectin core. The undulation pattern governs the mechanical integrity of the interface as well as the mechanical performance of assemblies of these cells while also increasing the surface area of the intercellular interfaces and hence influences intercellular processes such as transport or signaling. In certain embodiments, the invention relates to bio-inspired active hybrid materials or actuating devices based at least in part on biomimetic principles.

### Exemplary Applications

In certain embodiments, applications for controlling the material interface morphology transformation include the following:

1. Structural color: when the distance between layers is on the scale of the wavelength of visible light, if the wavelength of the wrinkling pattern in the material interface is tailored appropriately, interference of visible light of a certain wavelength will occur and, therefore, the composite will appear to be a particular color. The imparting of this color is reversible upon application of macroscopic stress or strain.

2. Multi-layer reflector: when the distance between layers is on the scale of the wavelength of visible light, if the wavelength of the wrinkling pattern in the material interface is tailored appropriately, visible light will be reflected. The reflection is reversible upon macroscopic stress or strain and the reflection rate can be tailored as well.

3. Acoustic mirrors, wave-guides, acoustic filters and ultrasonic transducers: Changing the interfacial morphology of the microstructure of phononic metamaterials allows for control of acoustic properties. These properties include: creating full phononic bandgaps and filtering of specific ranges of frequencies on demand.

4. Active composite materials with new tunable properties can be created by using the described methods. In particular, the electro-mechanical coupling of electro-active and soft dielectric elastomeric composites can be significantly enhanced. In certain embodiments, lower electric fields may be utilized. These materials can find applications as artificial muscles (e.g., large deformations actuated by electric field). The stiffening effect in magneto-rheological elastomers due to magnetic activation can be increased significantly. These materials can be used as sensors.

5. Manufacturing: In certain embodiments, the invention relates to novel manufacturing methods for tailoring interfacial morphology (porous, particle reinforced, layered). In certain embodiments, the overall mechanical properties of the material are also controlled. The proposed manufacturing methods are green (e.g., environmentally friendly) and inexpensive. For example, the stiffness, strength, and fracture toughness of filler-reinforced nanocomposites can be increased dramatically when the shape of the fillers is more sophisticated.

### Wrinkling of Interfacial Lavers in Stratified and Cellular Components

Overview

In certain embodiments, analytical and finite element based micromechanical models were developed for exploring the mechanisms of the wrinkling patterns of interfacial layers in layered and cellular composites. The critical compressive strain, initial wave-length, post-buckling wavelength and amplitude of thin interfacial layers embedded between compliant matrix layers or domains are derived as functions of the geometry (thickness of the interfacial layer) and material properties (Young's moduli and Poisson's ratios) of all phases. The model is shown to capture accurately the local instability (wrinkling) which leads to the undulating interfacial patterns and also reveals the conditions which govern the transition from a wrinkling pattern to macro long-wave mode instability. Mechanical experiments are performed on exemplary layered and cellular polymer composites fabricated via a 3D multi-material printer. The experimental results are in excellent agreement with the model. In these layered composites, the undulation pattern governs the mechanical integrity of the interface and the mechanical performance of the assemblies of these layers. The interface structure also governs other attributes and functions, including thermal, chemical, swelling, electrical properties and wave propagation responses. The ability actively to alter the interface structure enables on-demand tunability and control of wave propagation phenomenon (e.g., phononic and photonic), mechanical stiffness and deformation. The analytical and numerical models reveal biomimetic design principles to tailor mechanical and stimuli responsive hybrid layered and cellular structured, materials and devices for reversible multi-functional usage.

Analytical Micro-Mechanical Model for Layered Composites

Instabilities have been a subject of study in a number of composite material systems where structural mechanics approaches, energy methods, and Bloch wave analyses have been found to predict complex phenomenon. In certain embodiments, the invention relates to analytical models that predict the influences of geometry and material composition on instabilities in interfacial layers of layered and cellular composites. The models are further supported by finite element simulations and mechanical experiments. In certain embodiments, the theoretical, numerical, and experimental analysis and results cover a wide range of geometric and material parameters. In certain embodiments, the invention relates to examining the instabilities of interfacial layers within soft materials including the effect of large strain as found in rubber matrix composites, soft multi-layered composites, and soft multi-cellular structural composites found in biological systems. The analytical results provide design guidelines that govern interfacial and composite morphologies, and can explicitly quantify the critical load parameter, the wavelength of a wrinkling interface, and the post-buckling behaviors for a large variety of geometries and material compositions, supporting the development of novel multi-functional hybrid materials.

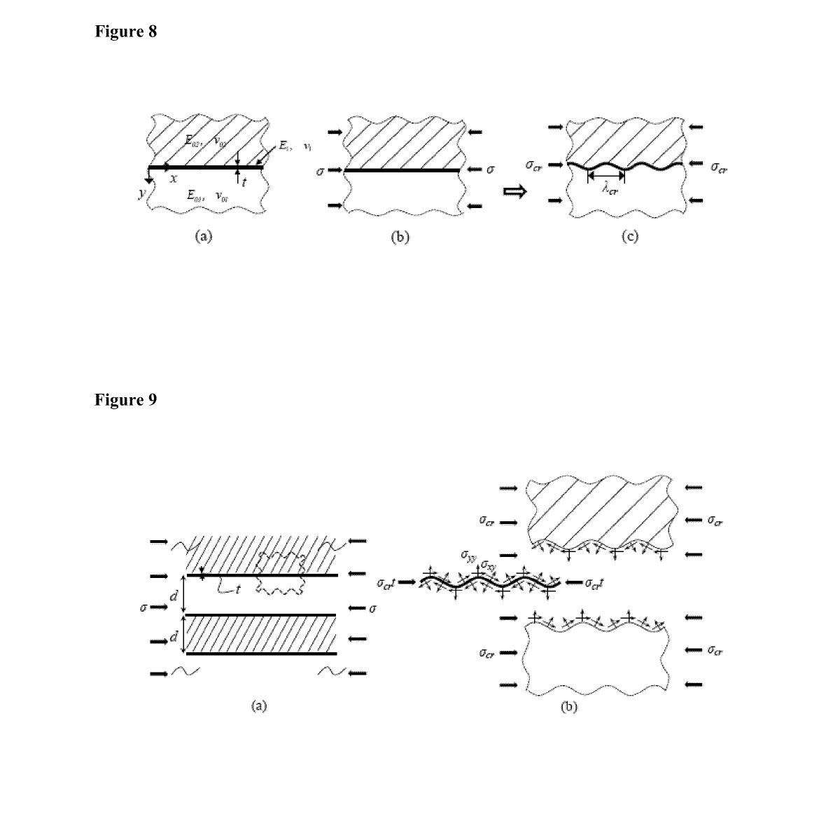

A schematic of an interfacial layer of thickness t bonded between two matrix mediums is shown in FIG. 8a. The Young's modulus and the Poisson ratio of the interfacial layer are (E₁,ν₁) and those of the two surrounding matrix regions are (E₀₁,ν₀₁) and (E₀₂,ν₀₂), respectively.

In certain embodiments, the interfacial layer is subjected to a compressive stress through direct compressive loading, through constrained growth of the adjacent matrix and/or other internally generated turgor pressure, as shown in FIG. 8b. The compressive stress will reach a critical value whereupon buckling of the interfacial layer is energetically favored over simple membrane compression and the interface will wrinkle, as shown in FIG. 8c. The scaling of the critical wavelength with the thickness of the interfacial layer and mechanical properties of the interfacial layer and matrix region is similar to that for the wrinkling of a stiff coating on a compliant substrate. Assuming a sinusoidal waveform for the lateral displacement of the interface, w(x)=w₁·cos(2πx/λ_{cr}), the bending energy per unit volume of the interfacial layer scales as U_{b}∝E₁t³A²/λ_{cr}⁴, where t is the thickness of the interfacial layer, A is the amplitude of the undulation, and λ_{cr} is the initial critical wavelength of the undulation. The local strain energy in the surrounding matrix scales as U_{S}∝(E₀₁+E₀₂)A²/λ_{cr}. Energy minimization gives the scaling laws for the critical wavelength λ_{cr}∝t(E₁/[E₀₁+E₀₂])^{1/3} and the critical strain ε_{cr} ∝ (E₁/[E₀₁+E₀₂])^{-2/3} (if assume ν₀₁=ν₀₂=ν₀). Beyond the scaling laws, closed-form solutions for the critical instability are obtained next by solving the governing differential equations.

The loading of a multi-layered composite is shown in FIG. 9a, under an external compressive stress σ. The free body diagram of the interfacial layer is shown in FIG. 9b, where σ_{yy} and σ_{xy} are the interfacial normal and shear stress components.

Hence, building on earlier models, the governing differential equation for the interfacial layer is given by:

$$D \frac{{d}^{4} w}{d {x}^{4}} + σ t \frac{{d}^{2} w}{d {x}^{2}} - \frac{t}{2} \frac{d {σ}_{xy}}{d x} = - {σ}_{yy} = - 2 \frac{c}{{λ}_{cr}} w ( x ) , \qquad ( 1 )$$

where D is the bending stiffness of the interfacial layer and w(x) is the deflection of the deformed layer. Furthermore, the stresses σ_{yy} and σ_{xy} can be related to the sinusoidal deflection w(x) of the interfacial layer by solving the boundary value problem of the matrix layers, as shown in FIG. 9b. The normal stress is σ_{yy}=2(c/λ_{cr})w(x), where c is a coefficient relating the deflection of the layer w(x) to the responsive transverse stress of the substrate acting on the layer. Periodic boundary conditions in both x and y holds at the boundaries of the matrix layer. By solving the normal stress of the two matrix layers, we obtain that for plane stress

$$c = \frac{2 π {E}_{01}}{( 3 - {v}_{01} ) ( 1 + {v}_{01} )} + \frac{2 π {E}_{02}}{( 3 - {v}_{02} ) ( 1 + {v}_{02} )} ;$$

and for plane strain,

$$c = \frac{2 π {E}_{01} ( 1 - {v}_{01} )}{( 3 - 4 {v}_{01} )} + \frac{2 π {E}_{02} ( 1 - {v}_{02} )}{( 3 - 4 {v}_{02} )} .$$

For a more general case, we also consider an internal pressure p within the compliant matrix, although the influences of the internal pressure on the critical strain will typically be small. For true physical systems, the internal pressure p represents the influence of a turgor pressure such as that occurring during cell growth. Considering the influence of turgor pressure p, Eq. (1) becomes:

$$D \frac{{d}^{4} w}{d {x}^{4}} + ( σ t - \frac{{v}_{1}}{1 - {v}_{1}} p t ) \frac{{d}^{2} w}{d {x}^{2}} - \frac{t}{2} \frac{d {σ}_{xy}}{d x} = - 2 \frac{c}{{λ}_{cr}} w ( x ) . \qquad ( 2 )$$

Due to the periodic boundary conditions, Eqs (1) and (2) are also governing equations for layered and cellular composites where the representative volume element (RVE) is shown in FIG. 8 and FIG. 9a. Generally, there are two types of instability based on the distance-to-thickness ratio of the interfacial layers:
(I) Dilute case—micro/local-instability: when the distance between two neighboring interfacial layers is large, micro/local-instability occurs. Interfacial layers behave independently of each other and the shear term in the general governing Eqs. (1) and (2) can be neglected, and it is only the interfacial layer that buckles.
(II) Concentrate case—macro/global-instability: when the distance between two neighboring interfacial layers is small, a macro/global-instability can occur such that the interfacial layers interact with each other and the shear term in the general governing Eqs. (1) and (2) is dominant. Therefore the interfacial layers and the matrix layers buckle together.

Micro/local-instability is the loss of uniqueness (bifurcation) of the uniform (straight) solution in a wavy pattern; while macro/global-instability is defined as the homogenized incremental moduli of the composite losing their rank-one convexity, or loss of ellipticity which can also be determined to be when the infimum of Bloch wave number is zero, indicating a mode with infinite long wavelength.

The term ‘micro-buckling’ has often been used differently in some of the prior literature. In fact, in many cases, ‘micro-buckling’ in the composite literature is actually the macro-instability. For example, the classical Rosen solution for predicting shear-mode buckling of uni-directional fiber composites is called micro-buckling of the fiber, when it is actually a macro/global instability corresponding to the infinite wave-length. Also the failure mechanism by which the composite suffers localized collapse within a kink band is indeed a result of post-bifurcation of a macro-instability, although in some literature it has been called micro-buckling. To avoid this potential confusion, we refer to the micro-instability of interfaces for the dilute case as ‘wrinkling’.

Discussion and Conclusions

As described in detail in Example 1, the analytical model together with the numerical approaches have great potential to be used to derive biomimetic principles for bio-inspired active hybrid materials or actuating devices, or functional graded materials. In particular, the change in the mechanical performance of the interfaces with changes in wavelength, and its impact on the overall mechanical and multi-functional performance of the layered and cellular structure together with the increased interfacial area per unit length on other properties (e.g., interfacial transport) are direct outcomes of this expansion-induced and mechanical tunable interfacial boundary. Also, we believe in the synthetic system and materials, the intrinsic length scale can be tuned by designing the complexity of the geometry and material composition. The potential applications are expected to be found in the design of stretchable electronics, networks of fluid channels in PDMS, multi-layer reflectors for structural coloration and camouflage, and composites for acoustic regulations and thermoregulation. In addition, the modeling results can provide deeper insights into the morphogenesis and phenotype diversity of wrinkling interfacial pattern in natural systems.

In certain embodiments, the invention relates to a mechanical model of an infinitely long interfacial layer embedded in two different soft matrix materials for both pre-buckling and post-buckling stages. The characteristics of local instability of a layered composite material/structure were captured accurately by this model. This model reveals the micro-mechanics of the formation of the undulated pattern in many natural systems.

In certain embodiments, the invention relates to the discovery that wrinkling (micro) to long-wave (macro) instability mode transition occurs in multi-layered composites when the ratio of the layer distance and the intrinsic wavelength of the interfacial layer is less than 1.25.

In certain embodiments, the invention relates to the discovery that, for layered composites with relatively low stiffness ratio (<˜10), wrinkling is the dominant mode of dissipating instability.

In certain embodiments, the invention relates to the discovery that the results of two additional methods including analytical, finite element simulations, mechanical experiments further support the modeling results. These two methods together with the analytical model provide a comprehensive tool kit for more advanced design of novel multi-functional hybrid composites, such as reversible bio-inspired multi-layer reflector and functional graded composites.

In certain embodiments, the invention relates to the discovery that, for cellular composites, the critical strain is mainly determined by the stiffness ratio and the thickness to cell size ratio of the network, the shape, assembly and aspect ratio of the cell has only a little influence on the critical buckling strain.

In certain embodiments, the invention relates to the discovery that, for cellular composites, two types of patterns are categorized and identified in the parametric space of geometry and material composition: type I, local repeating pattern; and type II, macro alternating pattern. For the system with type I patterns, the imperfection sensitivity increases when the stiffness ratio and the thickness to cell size ratio decreases. The system with type II pattern is usually not sensitive to imperfection.

In certain embodiments, the invention relates to the generating mix-type instability pattern by introducing a patterned heterogeneity in a larger length scale.

In certain embodiments, the invention relates to the discovery that, in general, the undulation pattern of local instability reduced the stress concentration at the intersection joints of the networks by redistributing and accommodating the localized deformation before losing stability.

In certain embodiments, the invention relates to the discovery that shape, assembly, and aspect ratio of the cells play important roles in distributing deformation in the network after local instability. Generally, an isotropic cell shape (when the aspect ratio is around one), and a larger aspect ratio facilitates the uniform distribution of deformation. The mid junctions significantly reduce the deformation localization due to the intersections of the network.

### Micromechanics Governing the Undulation Patterns of Inter-Cellular Boundaries of Plant Epidermis Cells

Overview

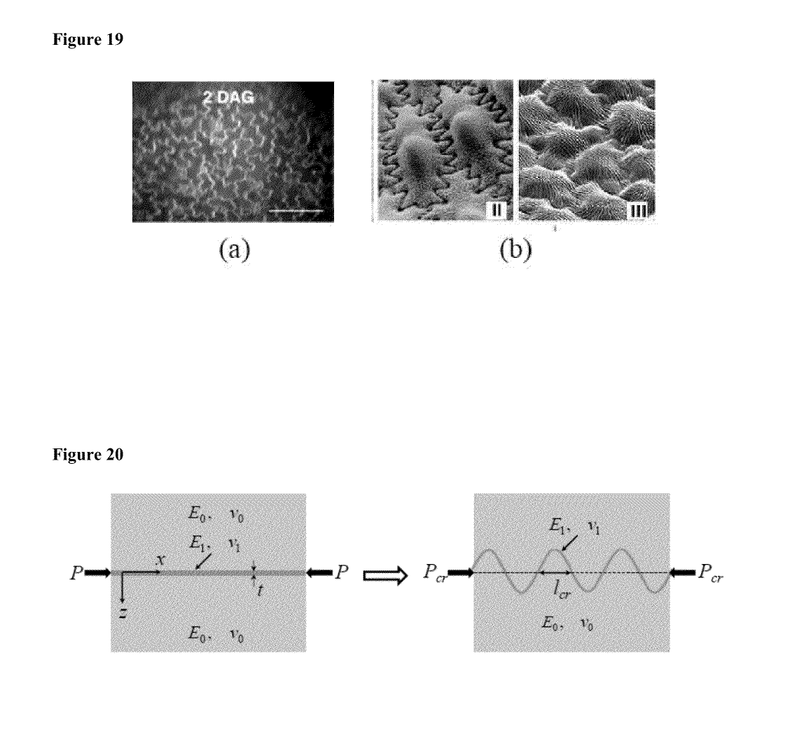

Plant epidermis is an intermediate layer of cells between the outmost cuticle layer and the ground tissue. It is an important architectural control element that regulates the growth properties of underlying tissues and, therefore, the size and shape of the plant organ. The inter-cellular boundaries of many plant epidermis cells exhibit a wavy undulating pattern (sometimes even zigzag, as shown in FIG. 19), such as the epidermis cells of Arabidopsis thaliana, Panicum javanicum, and the seed coat of Viscaria vulgaris. It is widely taken as an axiom in botany that, during growth, the plant cell wall constrains the rate of cell expansion and limits the final cell size, and the mechanical properties determine the volume and shape changes of plant cells, although direct experimental data to support this axiom is absent. In this invention, we developed analytical and numerical mechanical models to explore the underlying mechanisms and the role of cell walls in the formation of the undulating patterns of the inter-cellular boundaries of plant epidermis cells during growth.

Mechanical Modeling

Each plant cell consists of stiff semicrystalline cellulose fibrils, cross-linked by hemicellulose polymers, embedded in a gel-like matrix of pectins. We postulated that the undulation pattern of the intercellular boundaries of the epidermis cells is caused by the local instability of cell walls due to the compressive stress arising in the walls due to the constrained growth of the cells. Since plant epidermis cells are constrained by the cuticle layer and the ground tissue underneath, cell growth occurs preferentially within the plane of the epidermis. Therefore, the cellular structure of plant epidermis is approximated at a planar structure where the cells are modeled as a soft gel encapsulated within a thin but relatively higher modulus cell wall (captured mechanically as a “shell” or “beam”). To explore the underlying mechanisms of the local buckling instability of cell walls during cell growth, both analytical model and finite element models were developed to quantify the relationship between the characteristics of the undulation pattern and material properties and the geometry of the cell walls and the cell core.

A schematic of a mechanical model of the cell wall is shown in FIG. 20, in which an infinite long beam is perfectly bonded to an elastic medium on both sides. The Young's modulus and the Poisson ratio of the beam are and those of the matrix are E₀, ν₀. This structure is assumed to have a unit width, and a rectangular cross-section, with thickness t, and is subjected to in-plane compression.

An analytical model is derived which builds on earlier models which had determined the instability of a beam supported on one side by an elastic medium. Here, we derive the instability conditions, including the critical stress and the resulting non-dimensional wavelength l_{cr}/t, for the buckling of a beam supported embedded within an elastic medium (i.e., top and bottom surfaces of the beam are adhered to the elastic medium). The instability patterns are obtained as functions of the stiffness ratio E₁/E₀ between the beam and the matrix materials, and the Poisson ratio of the matrix ν₀.

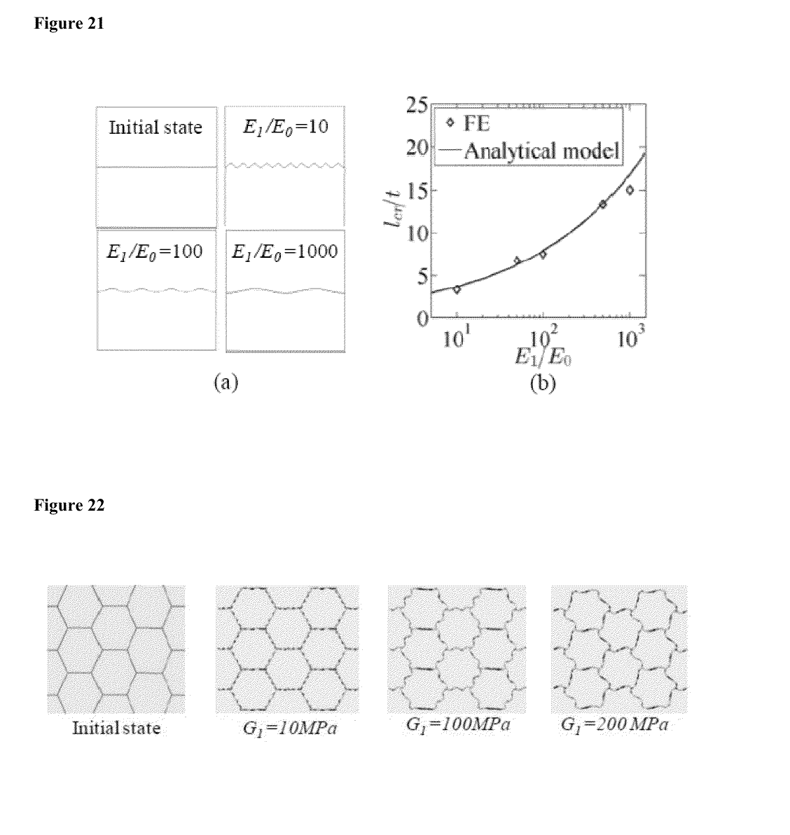

The analytical derivation was verified by finite element simulations. In the simulations the loading conditions are generated by the constrained thermal expansion of the beam, emulating a growth of the core. Periodic boundary conditions are used at the boundaries. Finite element simulation results of the wavy patterns of the beam are shown in FIG. 21. FIGS. 21(a) and 21(b) show that the new analytical model is quite accurate for a large range of stiffness ratio.

To mimic the growth of an array of plant epidermis cells, finite element models of a periodic hexagonal array of epidermis cells with edge length 35 μm and wall thickness t=1 μm are constructed as shown in FIG. 22. For simplicity, the cell core and wall materials are each taken to be homogeneous, although the cell walls are usually a composite like material reinforced by cellulose fibrils. The wall and core materials are modeled as hyperelastic and mechanically incompressible using a Neo-Hookean model, where the core material shear modulus is G₀=0.18 MPa and the cell wall shear modulus is G₁=10, 100 and 200 MPa as shown in FIG. 22. Both matrix and walls are subjected to constrained thermal expansion to mimic cell growth.

Discussion and Conclusions

As quantitatively predicted by the present analytical mechanical model of cell undulation, when the stiffness ratio between the wall and matrix increases, the non-dimensional critical compressive stress decreases and the non-dimensional wavelength increases, as shown in FIG. 21. Furthermore, finite element simulations of the hexagonal cell model qualitatively capture the undulation pattern observed during the diffuse growth of plant epidermis cells. By tailoring the stiffness ratio, a similar pattern to FIG. 19(a) can be obtained, as shown in FIG. 22. The hexagonal cell model has a more complicated geometry than the analytical model. Nevertheless, when the stiffness ratio increases, the numerical results of the characteristics of the undulation pattern of the hexagonal cell model show the same trend predicted by the analytical model. The analytical model together with the numerical approaches have great potential to be used to derive biomimetic principles for bio-inspired active hybrid materials or actuating devices. In particular, the change in the mechanical performance of the interfaces with changes in wavelength, and its impact on the overall mechanical performance of the multi-cellular structure, together with the increased inter-cellular surface area on other properties (e.g., inter-cellular transport) are direct outcomes of this growth-induced inter-cellular boundary. In addition, the modeling results can provide deeper insights into the morphogenesis and phenotypic diversity of plant epidermis cells.

Wave Propagation in Hyperelastic Structures with Instability Induced Wrinkled Interfaces

Theory

Consider a continuum body and identify each point in the undeformed configuration with its vector X. When the body is deformed the new location of the points is defined by mapping function x=χ(X; t). Thus, the deformation gradient is F=∂x/∂X, and its determinant, J=det F. For a conservative material whose constitutive behavior is described in terms of free-energy-density function Ψ(F), the first Piola-Kirchhoff or nominal stress tensor is given by

$$P = \frac{\partial Ψ ( F )}{\partial F} . \qquad ( 11 )$$

The corresponding true or Cauchy stress tensor is related to the nominal stress tensor via the relation σ=J¹PF^{T}. In the absence of body forces the equations of motion can be written in the undeformed configuration as

$$DivP = {ρ}_{0} \frac{{D}^{2} χ}{D {t}^{2}} , \qquad ( 12 )$$

where ρ₀ is the initial density, and the D²(•)/Dt² operator represents the material time derivative. If the deformation applied quasi-statically, the right hand part of Eq. (12) can be assumed to be zero and the equilibrium equation is obtained, namely

DivP=0 (13)

Consider next small amplitude motions superimposed on the equilibrium state. The equations of the incremental motions are

$$Div \dot{P} = {ρ}_{0} \frac{{D}^{2} v}{D {t}^{2}} , \qquad ( 14 )$$

where \dot{P} is an incremental change in the nominal stress and v is the incremental displacement. The incremental change in the deformation gradient is \dot{F}=Gradv.

The linearized constitutive law can be written as

\dot{P}ᵢⱼ=Aᵢⱼₖₗ\dot{F}ₖₗ (15)

with the tensor of elastic moduli defined as A_{iαkβ=∂}²Ψ/∂F_{iα}∂F_{kβ}. Under substitution of Eq. (15) into Eq. (14) the incremental motion equation takes form of

$${A}_{ijkl} {v}_{k , ij} = {ρ}_{0} \frac{{D}^{2} {v}_{i}}{D {t}_{2}} . \qquad ( 16 )$$

a. Wave Propagation in Generic Periodic Hyperelastic Media

Consider wave propagation in an infinite body with a generic periodic microstructure subjected to finite deformations. In both undeformed and deformed configurations, a periodic representative volume element (RVE) with the periodicity basis vector R can be identified such that

ψ(X+R)=ψ(X) (17)

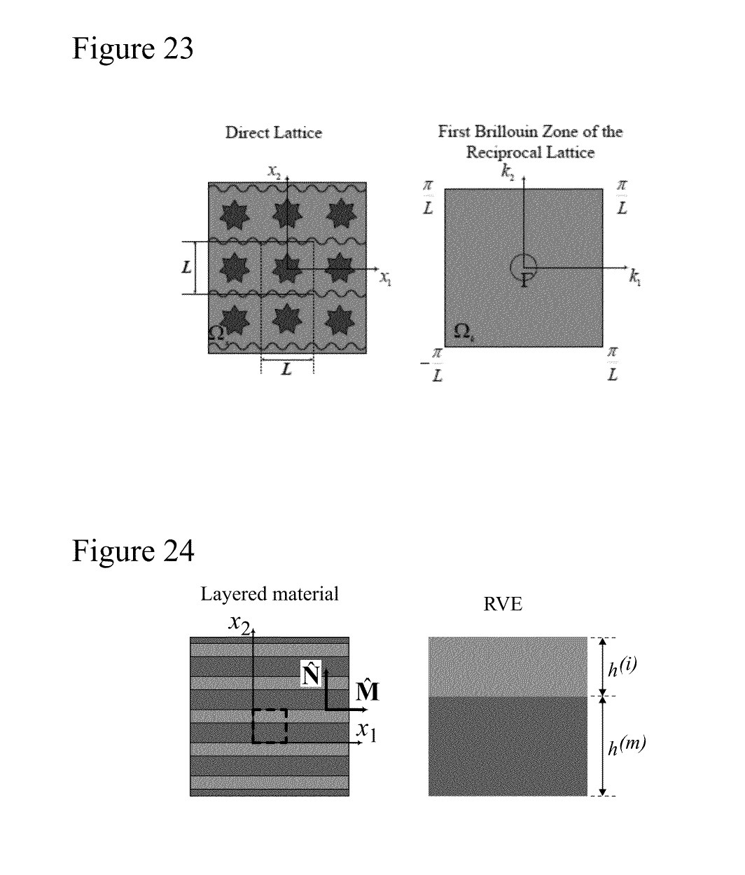

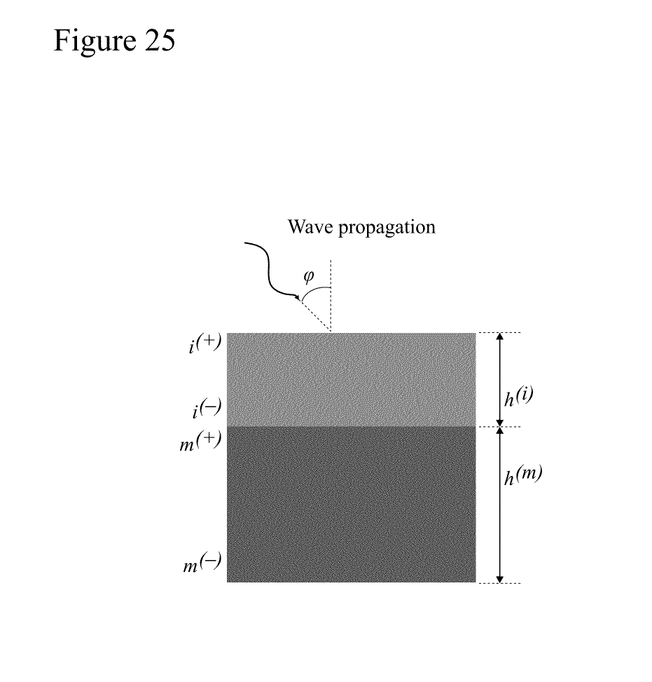

for any spatial function ψ. FIG. 23) shows an example of a periodic material with R=L₁ê₁+L² ê₂, note that in general the periodicity vector R may be oblique. The periodicity allows constructing a reciprocal lattice in the wave number k-space. The corresponding basis in the reciprocal k-space is

$$B = \frac{2 π}{{L}_{1}} {\hat{k}}_{1} + \frac{2 π}{{L}_{2}} {\hat{k}}_{2} . \qquad ( 18 )$$

Consider the solution of the form

v=U exp(−iωt), (19)

which upon substitution into equations of motion (16) yields

AᵢⱼₖₗU_{z,999 ij}+ρ₀ω²Uᵢ=0 (20)

To analyze the wave propagation in periodic structures for which no analytical solution is available we utilize the finite element method together with the Bloch-Floquet technique. In particular, the displacement is constrained by

v(X+R)=v(X)exp(ik·R), (21)

where k is the Bloch wave vector. The finite element of formulation of Eq. (20) is

K+ω²M=f, (22)

where K and M are the stiffness and mass matrix, respectively. The nodal forces f are set to be zero in the finite element solution as the body forces are absent and the traction boundary conditions are fulfilled automatically if the displacement boundary conditions (21) are satisfied.

Equations (22) and (21) produce the dispersion relation ω=ω(k).

b. Wave Propagation in Periodic Layered Hyperelastic Media

Consider periodic media made out of two alternating layers with volume fractions c^{(m)} and c⁽ⁱ⁾=1−c^{(m)}. Here and thereafter, the fields and parameters of the constituents are denoted by superscripts (•)⁽ⁱ⁾ and (•)^{(m)}, respectively. Geometrically, the layers are characterized by their thicknesses h^{(m)}=hc^{(m)} and h⁽ⁱ⁾=hc⁽ⁱ⁾ (see FIG. 24)). The direction normal to the layers plane is the laminate direction \dot{N}, and \hat{M} is a unit vector tangent to the interface, both in the undeformed configuration. Assuming that deformation is homogeneous in each phase, we have the mean deformation gradient \ddot{F}=c^{(m)}F^{(m)}+c⁽ⁱ⁾F⁽ⁱ⁾. For incompressible laminates the displacement continuity condition leads to

F^{(m)}= F̅(I+c⁽ⁱ⁾α\hat{M} [symbol] \ddot{N}), F⁽ⁱ⁾=\ddot{F}(I−e^{(m)}α\hat{M} [symbol] \ddot{N}), (23)

where α is a constant to be determined from the stress continuity condition at the interfaces [[P]] =0. Once the constitutive relations for phases are prescribed, a solution of the boundary value problem can be obtained.

Consider next wave propagation through the deformed material. We seek a solution for Eq. (16) in the form

υᵢ=\tilde{υ}ᵢ exp[ik(X₁ sin φ+βX₂−ct)], (24)

where \tilde{υ}ᵢ is the polarization, k is the wave number, c=ω/k is the phase velocity, ω is the angular frequency, φ is the incident angle. Substitution of the solution (24) into (16) leads to the eigenvalue problem from which the unknown parameter β is obtained. Thus, the solution (24) is modified as

$${v}_{i} = {\sum }_{n = 1}^{6} {\ddot{v}}_{i}^{( n )} exp ( i k {β}^{( n )} {X}_{2} ) exp ( i k [ {X}_{i} sin ϕ - ct ] ) , \qquad ( 25 )$$

where \tilde{υ}ᵢ⁽ⁿ⁾ are the eigenvectors associated with β⁽ⁿ⁾. The continuity conditions across interfaces imply

[[uᵢ]]=0 and [[\dot{P}ᵢ₂]]=0, (26)

Introducing s={u₁, u₂, u₃, P₁₂/^{ik}, P₂₂/^{ik}, P₃₂/^{ik}} we write the continuity condition as [[s]]=0. By making use of the solution form (25) we write

s=BEu, (27)

where u={\tilde{υ}₁⁽¹⁾, \tilde{υ}₁⁽²⁾, \tilde{υ}₁⁽³⁾, \tilde{υ}₁⁽⁴⁾, \tilde{υ}₁⁽⁵⁾, \tilde{υ}₁⁽⁶⁾}, E is the diagonal matrix given by E=diag {expikβ⁽ⁿ⁾X₂} and

$$B = ( \begin{matrix}1 & 1 & … & 1 \\ {\tilde{v}}_{2}^{{( 1 )}^{*}} & {\tilde{v}}_{2}^{{( 2 )}^{*}} & … & {\tilde{v}}_{2}^{{( 6 )}^{*}} \\ {\tilde{v}}_{3}^{{( 1 )}^{*}} & {\tilde{v}}_{3}^{{( 2 )}^{*}} & … & {\tilde{v}}_{3}^{{( 6 )}^{*}} \\ {d}_{1}^{{( 1 )}^{*}} & {d}_{1}^{{( 2 )}^{*}} & … & {d}_{1}^{{( 6 )}^{*}} \\ {d}_{2}^{{( 1 )}^{*}} & {d}_{2}^{{( 2 )}^{*}} & … & {d}_{2}^{{( 6 )}^{*}} \\ {d}_{3}^{{( 1 )}^{*}} & {d}_{3}^{{( 2 )}^{*}} & … & {d}_{3}^{{( 6 )}^{*}}\end{matrix} ) \qquad ( 28 )$$

in which dᵢ⁽ⁿ⁾ relates the incremental stresses and displacement and is obtained from Eq. (15). In (28), the notation (•)⁽ⁿ⁾* is used for the values divided by \tilde{υ}₁⁽ⁿ⁾. Writing the solution for a layer (m) and noting that E^{(m)-}=I with the appropriate choice of the local coordinate system we obtain the local transfer matrix T^{(m)} that translates the fields through the layer s^{(m)+}=T^{(m)}s^{(m)-}, namely

T^{(m)}=B^{(m)}E^{(m)+}B^{(m)-1}, (29)

A similar procedure is applied for a layer (i) to obtain the local transfer matrix T⁽ⁱ⁾. Noting that s^{(m)+}=s⁽ⁱ⁾⁻ we obtain the transfer matrix for two adjacent layers T=T^{(m)}T⁽ⁱ⁾ and, consequently

s(h)=Ts(0), (30)

Note that the procedure can be repeated N times to obtain the global transfer matrix for N alternating layers of an infinite periodic or finite size composite

T=T⁽¹⁾T⁽²⁾ . . . T^{(N)}. (31)

The periodicity implies that

s(h)=s(0)exp(ikh cos φ). (32)

Equations (32) and (30) yield

det(T−I exp(ikh cosφ))=0. (33)

Equation (33) provides the dispersion relations between ω=ω(k,φ).

Results

In this section we examine the behavior of hyperelastic materials capable of large deformation. In particular, the strain energy-density function corresponding to the Gent model is utilized

$$ψ ( F ) = - \frac{μ {J}_{m}}{2} ln ( 1 - \frac{{I}_{1} - 3}{{J}_{m}} ) - μ ln J + ( \frac{κ}{2} - \frac{μ}{{J}_{m}} ) {( J - 1 )}^{2} , \qquad ( 34 )$$

where μ is the initial shear modulus, κ is the bulk modulus and I₁=tr(F^{T}F) is the first invariant of the right Cauchy-Green tensor. The model neatly covers the stiffening of the material with the deformation, as the deformation, attends the level of I₁=3+Jₘ, the energy becomes unbounded and the dramatic increase of stresses occurs. Consequently, Jₘ is the locking parameter. Clearly, when Jₘ→∞, the energy-density function (34) reduces to the neo-Hookean one, namely

$$ψ ( F ) = \frac{μ}{2} ( {I}_{1} - 3 ) - μ ln J + \frac{κ}{2} {( J - 1 )}^{2} . \qquad ( 35 )$$

The material properties of the constituents examined in the Result section are summarized in Table I.

TABLE I
Constituent Properties

| Material | μ [MPa] | ρ₀ [g/cm³] | κ [GPa] | Jₘ |
|---|---|---|---|---|
| Neo-Hookean Matrix | 1.08 | 1.05 | 2 | ∞ |
| Gent Matrix | 1.08 | 1.05 | 2 | 0.5 |
| Gold | 28.73 · 10³ | 19.3 | 230 | 0.5 |

Loading Paths. Although the analysis is rather general and can be applied for material subjected to any deformation F, the examples are given for in plane tension and shear mode of deformation. The corresponding to these cases mean deformation gradients are

(A) in plane tension

\ddot{F}=λê₁ [symbol] ê₁+λ⁻¹ê₂ [symbol] ê₂+ê₃ [symbol] ê₃ (36)

and
(B) in plane shear

\ddot{F}=γê₁ [symbol] ê₂ê₁ [symbol] ê₁+ê₂ [symbol] ê₂+ê₃ [symbol] ê₃. (37).

a. Homogeneous infinite material

First, we apply the analysis developed in the Section II for an infinite homogeneous medium with energy-density function given by (34).

Tension. For the tensile loading (36) the expressions for the frequencies of the in-plane transverse and longitudinal waves are rather complicated but still are closed form exact expressions ω₁^{(G)} [symbol] =ω₁(λ, k) and ω₂^{(G)}=ω₂(λ, k).. Remarkably, the frequencies of the out-of plane transverse wave take the compact form

$${ω}_{3}^{( G )} = {( \frac{{J}_{m}}{2 + {J}_{m} - {λ}^{2} - {λ}^{- 2}} )}^{1 / 2} \sqrt{\frac{μ}{ρ}} \vert k \vert . \qquad ( 38 )$$

Note that when the locking parameter Jₘ→∞,, the frequencies of the transverse waves reduce to the compact expression

$${ω}_{1}^{( n H )} = {ω}_{3}^{( n H )} = \sqrt{\frac{μ}{ρ}} \vert k \vert \qquad ( 39 )$$

and the corresponding frequency of the longitudinal waves is

$${ω}_{2}^{( n H )} = \sqrt{\frac{( κ + μ ) [ {k}_{1}^{2} {λ}^{- 2} + {k}_{2}^{2} {λ}^{2} + {k}_{3}^{2} ] + μ {\vert k \vert}^{2}}{ρ}} . \qquad ( 40 )$$

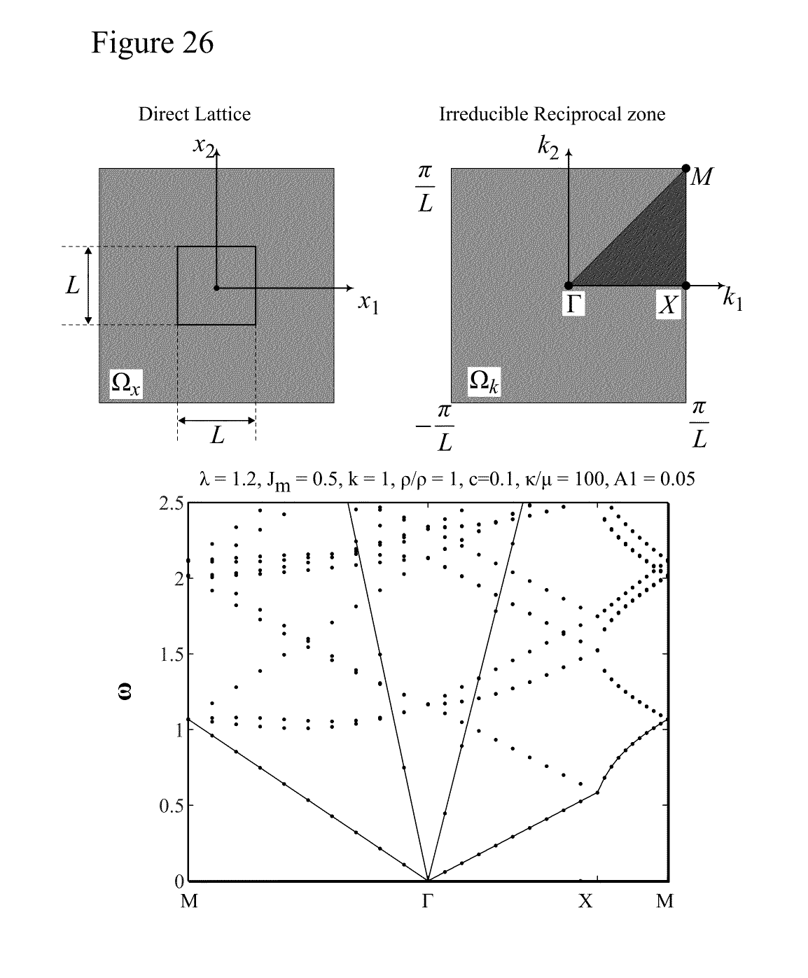

For the homogenous material with the stiffening behavior (34) the wave propagation depends on the applied deformation. Differently, for neo-Hookean materials the transverse waves will propagate unaffected by the deformation while the longitudinal waves are deformation sensitive. An example of dispersion diagrams is presented in FIG. 26) for Gent material subjected to tension λ=1.2. The normalized frequencies \ddot{ω} [symbol] =ω\sqrt{ρ/μ}/(2πL) is presented as function of k along the path M-Γ-X-M. L represents the linear size of the considered RVE. The numerical results coincide with the exact analytical solution for both Gent and, consequently neo-Hookean materials.

Shear. Similarly to the tension case, when a shear deformation is applied (37), the explicit expressions for the frequencies ω₁=ω₁(γ,k) and ω₂=ω₂(γ,k) can be obtained. The out-of-plane transverse waves will propagate with

$${ω}_{3}^{( G )} = {( \frac{{J}_{m}}{{J}_{m} - {γ}^{2}} )}^{1 / 2} \sqrt{\frac{μ}{ρ}} \vert k \vert . \qquad ( 41 )$$

For neo-Hookean material (Jₘ→∞) the in-plane and out-of-plane transverse waves propagate with the frequencies given in (39). We note that expressions (39) for the transverse waves are independent of deformation and will be obtained in the same form for any arbitrary deformation F̅. The corresponding longitudinal wave propagation however depends on the deformation

$${ω}_{2}^{( n H )} = \sqrt{\frac{( κ + μ ) {k}_{1} γ ( {k}_{1} γ - 2 {k}_{2} ) + ( κ + 2 μ ) {\vert k \vert}^{2}}{ρ}} . \qquad ( 42 )$$

The explicit expressions for the frequencies produce the identical to FE procedure results and are not shown here.

b. Layered Material

Consider next layered materials discussed in Section II. For a composite with neo-Hookean phases (35), the solution of the boundary value problem is given by

$$α = \frac{{μ}^{( i )} - {μ}^{( m )}}{{c}^{( m )} {μ}^{( i )} + {c}^{( i )} {μ}^{( m )}} \frac{\overline{F} \hat{N} \cdot \overline{F} \hat{M}}{\overline{F} \hat{M} \cdot \overline{F} \hat{M}} . \qquad ( 43 )$$

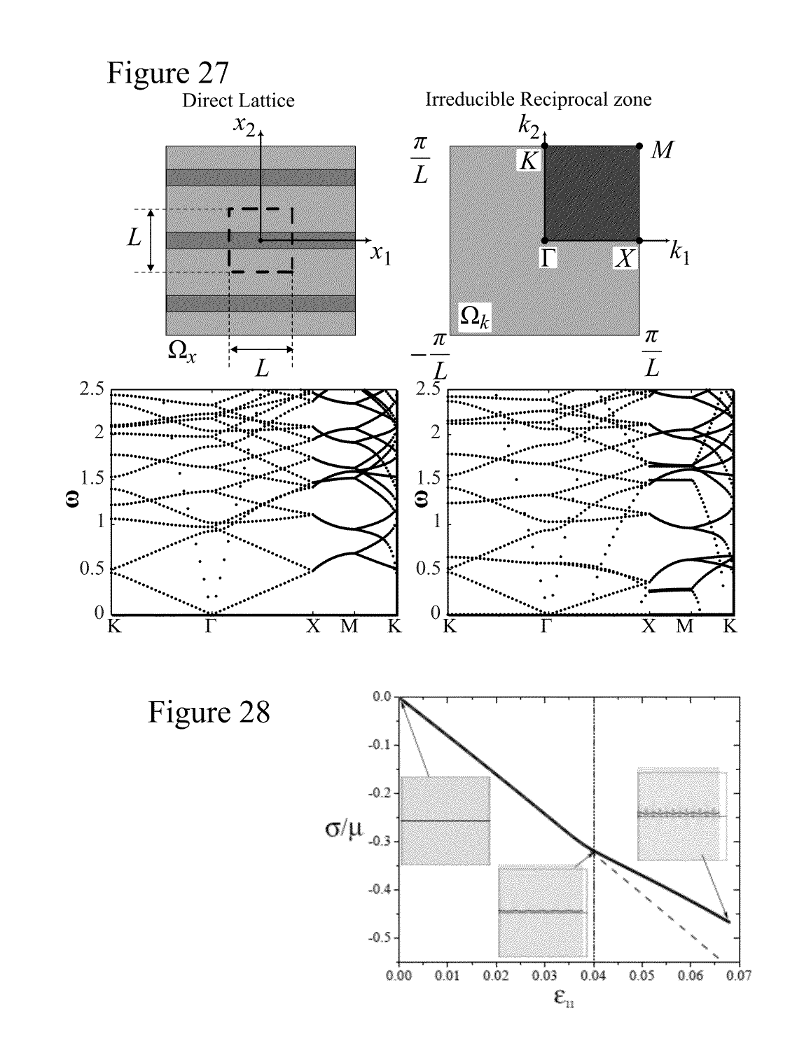

A rather complicated closed form expression is obtained for a composite with more general Gent behavior of the phases (34). The solution defines the deformed state of the medium and the small amplitude waves are superimposed upon this state. Following the analysis of Section II with the specification of Gent model (34) for the constituents, an analytical expression for the dispersion relations ω=ω(k) is obtained. The analytical results are identical to these obtained from the FE procedure and an example of representative dispersion diagram is shown in FIG. 27) for a composite in the undeformed state (bottom left) and subjected to compression λ=0:95 (bottom right). Indeed, an applied deformation transform the dispersion diagrams, and consequently the wave propagation is altered as it is clearly shown in FIG. 27. We note that in agreement with previous results the layered material is found to bifurcate if subjected to compression. This, in turn give rises to microstructure transformations and appearance of wrinkled interfaces. The influence of this phenomenon on the wave propagation is studied in the following sections.

c. Layered Material with Wrinkled Interfaces

When layered media is compressed along the layer direction, bifurcations may occur leading to a sudden formation of wrinkled interfaces characterized by different wavelengths. These wavelengths can be estimated by where υ^{(m)}=^{0.5(3κ}^{₍ₘ₎}^{-μ}^{₍ₘ₎}^{)/(μ}^{₍ₘ₎}^{+3κ}^{₍ₘ₎}⁾ is Poisson's ratio of the soft phase and h denotes the thickness of the stiffer layer (Li et al, 2012). Moreover, the critical strain ε_{cr} can be estimated by

$${ɛ}_{cr} = 2.47 {( \frac{{l}_{cr}}{h} )}^{- 2} . \qquad ( 45 )$$

Although, Eqs. (44) and (45) are derived in frame of small deformation elasticity and for the stiff phase dilute limit, they provide a fair estimation for finite deformations as well (Li et al, 2012). Here we make use of these results to introduce a small amplitude initial imperfection in FE model. The initial imperfection is introduced as a small amplitude harmonic shape of the interfaces in the undeformed state, namely X₂=S sin (πX₁/l_{cr}). Further, when the compressive deformation is applied the imperfection grows slowly until the critical compressive strain is attained. At this point, the sudden change in microstructure occurs and the wrinkles become visible and the amplitude increases rapidly with further deformation. FIG. 28 shows the dependence of mean specifiable stress σ= σ̅₁₁− σ̅₂₂ on the applied strain ε of the composite with volume fraction of the stiffer layers c⁽ⁱ⁾=0:01 and stiffness contrast ratio r=μ₍ᵢ₎/μ^{(m)}=100. the continuous blue curve represents the FE results while the dashed red curve is the exact analytical solution for at layers given by

σ^{(cr)}= μ̅(λ²−λ⁻²), (46)

where μ̅=c^{(m)}μ^{(m)}+c⁽ⁱ⁾μ⁽ⁱ⁾. The vertical dashed line denotes the critical strain calculated from Eqs. (44) and (45). Note that at the onset of bifurcations the material softens and the slope of the stress-strain curve decreases. When the wrinkles are formed the stiff layers expend releasing the compressive stresses and leading to the observed overall softening of the composites.

To highlight the influence of the wrinkled interfaces on the wave propagation, we show dispersion diagrams (i) at the undeformed state ε=0; (ii) at the onset of bifurcation and wrinkle formation ε˜ε_{cr}; (iii) at a developed wrinkled state ε>ε_{cr}. An illustration of these 3 states is shown in FIG. 28.

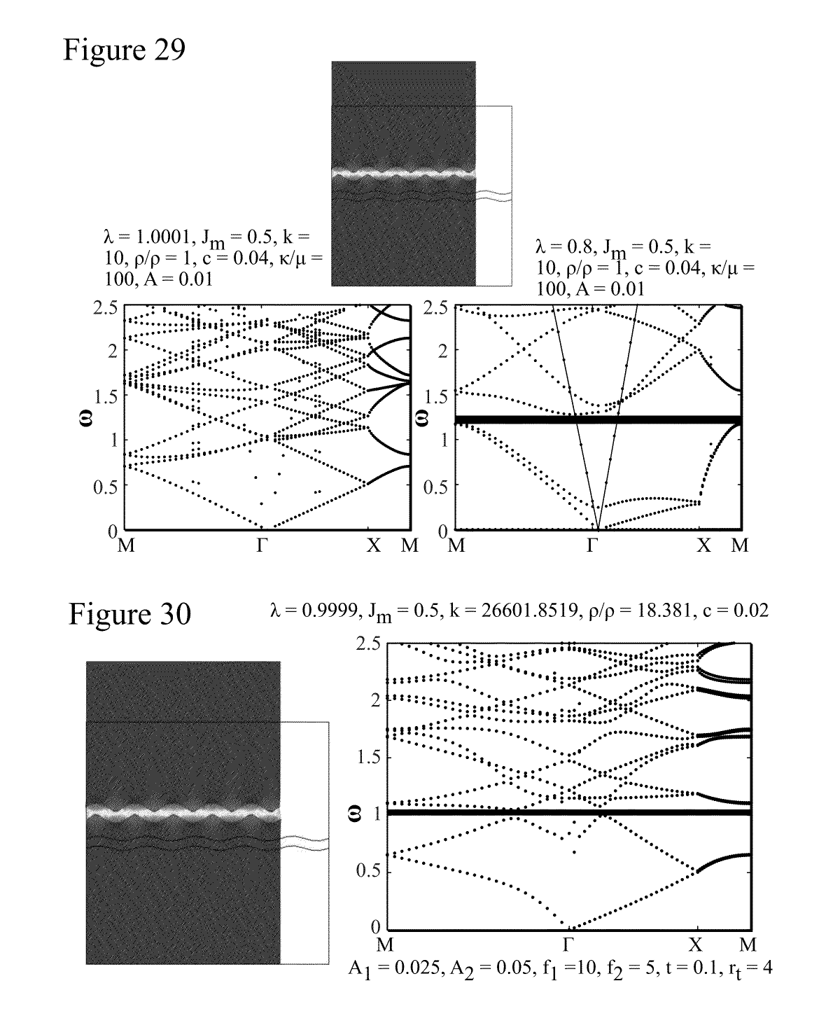

(1) Periodic structures with initial imperfection in identical stiffer layers. First, we examine periodic layered materials with initial imperfection in identical stiffer layers embedded in soft matrix. FIG. 29 shows an example of dispersion diagrams for a composite with initial stiffness ratio r=μ⁽ⁱ⁾/μ^{(m)}=10 and equal densities. The dispersion diagram of the undeformed structure is on the left, while the subjected to compression of λ=0:8 is on the right. In the undeformed configuration the amplitude of the wrinkled interfaces is relatively small a=0:01 and the quasi-longitudinal and quasi-shear waves are found to propagate at the considerable range of frequencies. When the material is compressed, the amplitude of the wrinkled interfaces increases and the dispersion diagrams alter. In particular, the quasi shear waves do not propagate in the range of the normalized frequencies ω=1.2:1.25.

Furthermore, when a stronger contrast between the composite constituents is provided, complete band-gaps can be found. To provide an example of such situation we use gold as the stiff phase. Indeed, the behavior of Gold is characterized by an elasto-plastic constitutive law, however, here we subject the material only to shear deformation, and consequently, the deformation is mostly accommodated by the soft matrix, whereas the deformation and stress levels in the gold phase are sufficiently small and the neo-Hookean model (35) can be used. An example of the dispersion diagrams of the material with Gold-Matrix wrinkled interfaces are presented in FIG. 30 for the undeformed material. Here, the geometry effect combined with strong contrasts of the phase properties to create a band-gap for quasi-shear and longitudinal waves in the range of ω=1:1:05.

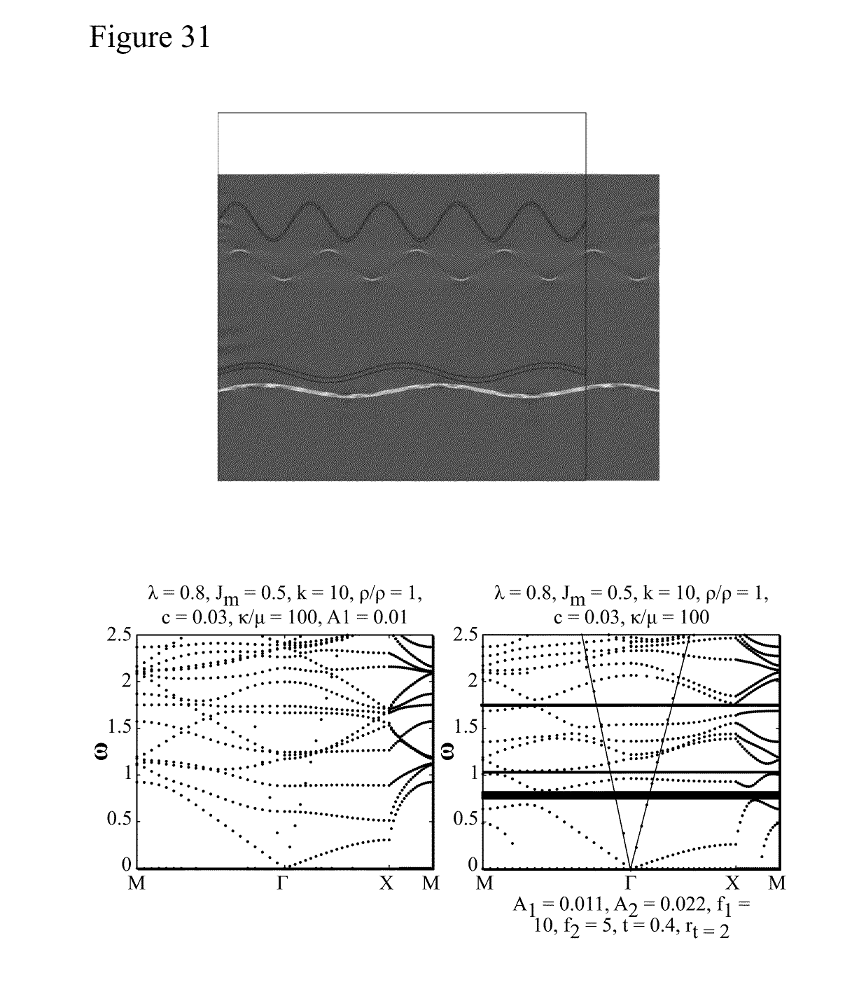

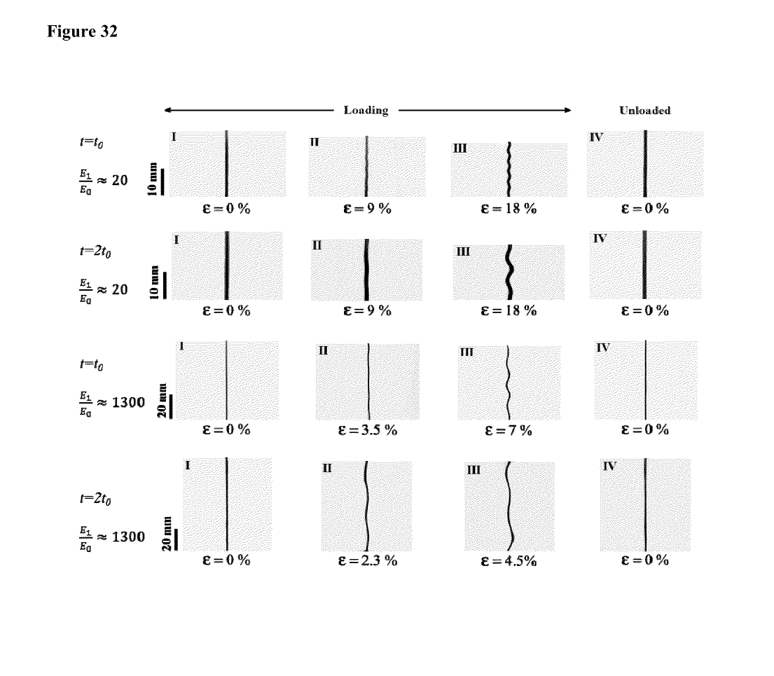

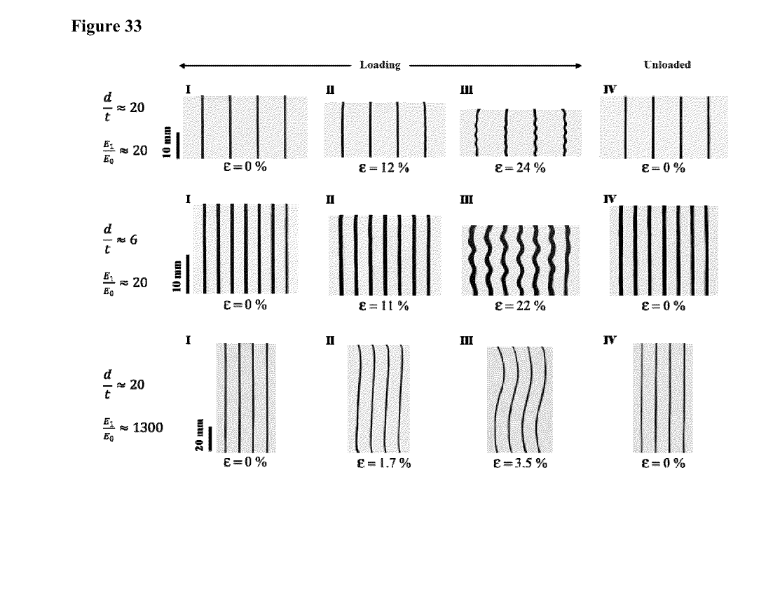

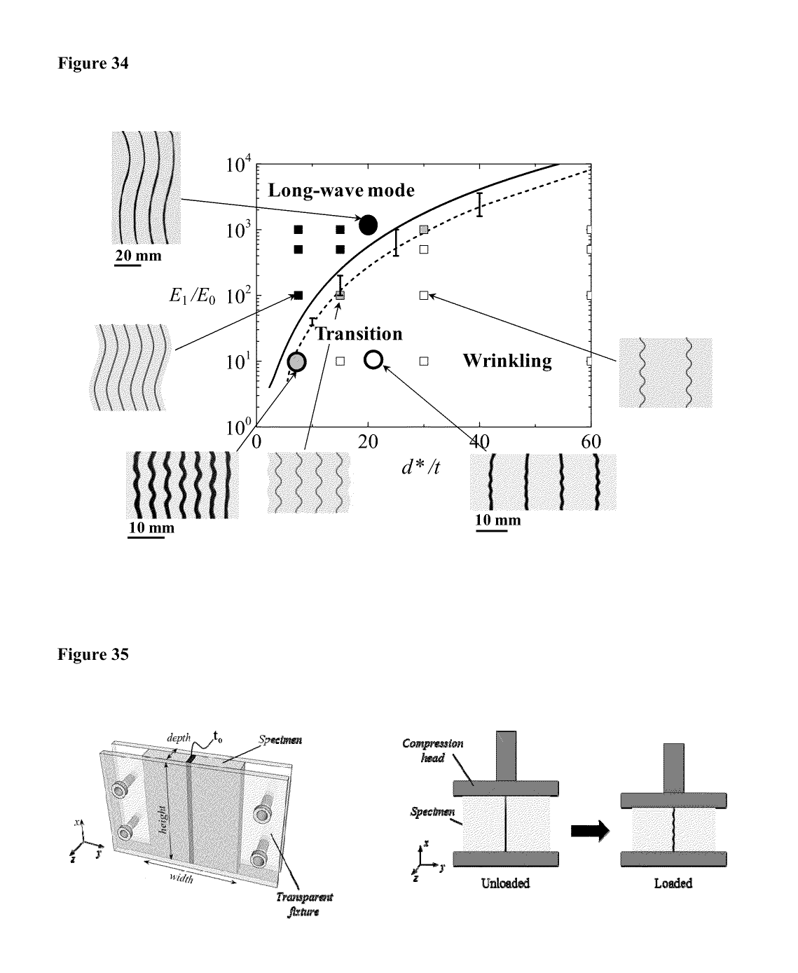

(2) Two layers of different thicknesses. Li et al (2012) recently showed that the thicknesses of the alternating layers play a crucial role in the formation of the wavy interfaces. For example, when a system of embedded in soft matrix stiff layers are characterized by different thicknesses, the layers form the wavy interfaces with different periods and amplitudes. Moreover, when the volume fraction of the layers is high enough, the stiff layers starts interacting and new patterns may be created. Here, we make use of the phenomenon to control the wave propagation. In particular, we examine the periodic system with two different thicknesses of stiff layers embedded in soft matrix. An example of the dispersion diagram is presented in FIG. 31) for a material with the initial stiffness contrast ratio r=10, volume fraction of the stiffer phase c⁽ⁱ⁾=0.03, the distance between the interfaces axis is ΔH/H=0.4 and the thickness ratio of the stiffer layers is rₜ=4, the characteristic periods of the wavy interfaces is T₁=⅕ and T₂=⅖. The amplitudes are a₁=0.01 and a₂=0.02 for the left figure and a₁=0.011 and a₂=0.022 for the right. Note that the relatively small difference in the interface amplitude parameter leads to sudden (but still controllable) appearance of quasi shear wave filters.

### Exemplary Methods

In certain embodiments, the invention relates to a method, comprising the steps of:
providing a first material and a second material;
contacting the first material with the second material to form a composite material with a material interface;
applying a first force to the composite material, wherein the first force transforms the morphology of the material interface, thereby forming a transformed composite material.

In certain embodiments, the invention relates to any one of the aforementioned methods, wherein the first force is calculated to produce a desired transformation in the morphology of the material interface.

In certain embodiments, the invention relates to any one of the aforementioned methods, wherein the first force is a load or deformation condition.

In certain embodiments, the invention relates to any one of the aforementioned methods, wherein the first force is stretch or strain.

In certain embodiments, the invention relates to any one of the aforementioned methods, wherein the force is stretch or strain; and the force is applied substantially in-plane with the material interface.

In certain embodiments, the invention relates to any one of the aforementioned methods, wherein the first force is applied directly or indirectly to the composite material.

In certain embodiments, the invention relates to any one of the aforementioned methods, wherein the first force is constrained swelling. In certain embodiments, the invention relates to any one of the aforementioned methods, wherein the first force is constrained swelling due to a change in pH, humidity, light, temperature, or electricity.

In certain embodiments, the invention relates to any one of the aforementioned methods, wherein the first force is thermal expansion.

In certain embodiments, the invention relates to any one of the aforementioned methods, wherein the first force is phase transformation.

In certain embodiments, the invention relates to any one of the aforementioned methods, wherein the material interface is transformed from being substantially straight to having a wavy pattern.

In certain embodiments, the invention relates to any one of the aforementioned methods, wherein the wavelength or the amplitude of the material interface is transformed.

In certain embodiments, the invention relates to any one of the aforementioned methods, wherein a hierarchically structured interface is formed.

In certain embodiments, the invention relates to any one of the aforementioned methods, further comprising the step of removing the first force from the composite material.

In certain embodiments, the invention relates to any one of the aforementioned methods, wherein the first material or the second material is an elastomer.

In certain embodiments, the invention relates to any one of the aforementioned methods, wherein the first material or the second material is an elasto-plastic.

In certain embodiments, the invention relates to any one of the aforementioned methods, wherein the first material or the second material is a polymer or an alloy. In certain embodiments, the invention relates to any one of the aforementioned methods, wherein the first material or the second material is a shape-memory polymer or a shape-memory alloy.

In certain embodiments, the invention relates to any one of the aforementioned methods, wherein the first material or the second material is a hydrogel. In certain embodiments, the invention relates to any one of the aforementioned methods, wherein the first material or the second material is a stimuli-responsive polymer.

In certain embodiments, the invention relates to any one of the aforementioned methods, wherein the first material or the second material is an electroactive polymer.

In certain embodiments, the invention relates to any one of the aforementioned methods, wherein the first material or the second material is porous.

In certain embodiments, the invention relates to any one of the aforementioned methods, wherein the first material and the second material are the same.

In certain embodiments, the invention relates to any one of the aforementioned methods, wherein the first material and the second material are different.

In certain embodiments, the invention relates to any one of the aforementioned methods, wherein the first material or the second material comprises cells. In certain embodiments, the invention relates to any one of the aforementioned methods, wherein the first material or the second material is a plurality of cells.

In certain embodiments, the invention relates to any one of the aforementioned methods, wherein the composite material is a cellular structure with a hexagonal pattern (i.e., the material interface is in a hexagonal pattern).

In certain embodiments, the invention relates to any one of the aforementioned methods, wherein the material interface comprises a third material. In certain embodiments, the invention relates to any one of the aforementioned methods, wherein the third material is a solid, a liquid, or a gas. In certain embodiments, the invention relates to any one of the aforementioned methods, wherein the third material is porous.

In certain embodiments, the invention relates to any one of the aforementioned methods, wherein the transformed composite material is a layered structure.

In certain embodiments, the invention relates to any one of the aforementioned methods, wherein the transformed composite material is a cellular structure with a floral pattern.

In certain embodiments, the material interface can experience morphology transformation upon direct or indirect application of load or deformation, and the transformation alters the interfacial geometry from straight to wavy patterns or alters the waviness of the geometry or provides a hierarchically structured interface.

In certain embodiments, when the materials are elastomeric, upon the removal of the load or deformation condition, the interfacial morphology is recovered. So all the attributes based on the morphology transformation become switchable.

In certain embodiments, when the materials are elasto-plastic, the new morphology based on the transformation is preserved.

In certain embodiments, when the materials are shape memory polymers/alloys, or stimuli responsive hydrogels and electroactive polymer: the new morphology can be either switched on and off or can be retained upon cooling below critical temperature such as the glass transition temperature and/or by cross-linking prior to unloading.

In certain embodiments, macroscopic stress and strain triggering the morphology transformation can be generated in a large variety of ways including mechanical far field or local loads, constrained swelling due to different stimuli (PH, humidity, light, temperature, electricity etc.), thermal expansion, phase transformation.

In certain embodiments, for multi-layered structures/materials, the smooth interfacial layers can be tuned into wavy patterns with various wavelengths and amplitudes. In certain embodiments, the tunable patterns are achieved by varying material composition, the thickness of the interfacial layer and/or the distance between the layers. In certain embodiments, functional graded material can be developed by varying the material composition and the layer thickness of each material.

In certain embodiments, for cellular composites, the smooth interfacial layers between the cells can be tuned into wavy patterns with various wavelengths, amplitudes and types. In certain embodiments, the tunable patterns are achieved by varying material composition, the thickness of the interfacial layer and/or the shape of the cells. In certain embodiments, the overall geometric pattern of the cellular structure can be tuned from hexagonal to a floral pattern.

In certain embodiments, for structured materials containing inclusions with different phases, the smooth interfacial layers between the inclusions and the matrix can be tuned into wavy patterns with various wavelengths and amplitudes. In certain embodiments, the phase of the inclusion can be solid, fluid or gas. In certain embodiments, porous materials are made (e.g., when the inclusion phase is replaced by pores or voids). In certain embodiments, tunable patterns are achieved by varying material composition, the thickness of the interfacial layer and/or the shape and arrangement of the inclusions

In certain embodiments, by including a regulation layer around the interfacial layer, the interfacial morphology can be tuned into a higher order waveform for all geometries.

In certain embodiments, the aforementioned methods can be used to create sophisticated interfacial morphologies. For example:
i. Mixed structural geometries (such as multi-layered structure with cellular composite as matrix)
ii. Mixed type I and type II patterns

In certain embodiments, the invention relates to any one of the aforementioned methods, wherein the composite material is stretched from about 0.01% to about 300% in the first dimension or the second dimension. In certain embodiments, the invention relates to any one of the aforementioned methods, wherein the composite material is stretched from about 0.01% to about 200% in the first dimension or the second dimension. In certain embodiments, the invention relates to any one of the aforementioned methods, wherein the composite material is stretched from about 0.01% to about 150% in the first dimension or the second dimension. In certain embodiments, the invention relates to any one of the aforementioned methods, wherein the composite material is stretched from about 0.01% to about 100% in the first dimension or the second dimension. In certain embodiments, the invention relates to any one of the aforementioned methods, wherein the composite material is stretched from about 0.01% to about 50% in the first dimension or the second dimension. In certain embodiments, the invention relates to any one of the aforementioned methods, wherein the composite material is stretched from about 0.01% to about 45% in the first dimension or the second dimension. In certain embodiments, the composite material is stretched about 0.01%, about 0.1%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 40%, about 50%, about 60%, about 70%, about 80%, about 90%, about 100%, about 150%, about 200%, or about 300% in the first dimension or the second dimension. In certain embodiments, the degree of stretching in a composite material relates to the amplitude of the waves created in the final composite material, or the height of the features.

In certain embodiments, the invention relates to any one of the aforementioned methods, wherein the ratio of the stretch in the second dimension (ε^{2nd}) to the stretch in the first dimension (ε^{1st}) is about 0 to about 10, about 0.1 to about 10, or about 1 to about 5.

In certain embodiments, the invention relates to any one of the aforementioned methods, wherein the first material or the second material comprises an elastomeric material or a thermoplastic material. In certain embodiments, the invention relates to any one of the aforementioned methods, wherein the first material or the second material is a thermoplastic elastomer, a crosslinked elastomer, or a filled elastomer.

In certain embodiments, the invention relates to any one of the aforementioned methods, wherein the first material or the second material comprises an elastomeric material; and the elastomeric material is selected from the group consisting of polyisoprene, polybutadiene, polychloroprene, isobutylene-isoprene copolymers, styrene-butadiene copolymers, butadiene-acrylonitrile copolymers, ethylene-propylene copolymers, and ethylene-vinyl acetate copolymers.

In certain embodiments, the invention relates to any one of the aforementioned methods, wherein the composite material is stretched using a device. In certain embodiments, the device is a sample holder. In certain embodiments, the device comprises a first set of jaws and a second set of jaws. In certain embodiments, the device comprises a first screw and a second screw. In certain embodiments, the first screw controls the stretching in the first dimension; and the second screw controls the stretching in the second dimension.

In certain embodiments, the invention relates to any one of the aforementioned methods, wherein the first dimension and the second dimension are orthogonal.

In certain embodiments, mathematical or mechanical models may be used to calculate the parameters necessary to create desired patterns, shapes, and sizes on the composite material.

### Exemplary Transformed Composite Materials

In certain embodiments, the invention relates to a transformed composite material.

In certain embodiments, the invention relates to a transformed composite material made by any one of the aforementioned methods.

In certain embodiments, the material interface of the transformed composite material comprises a pattern; and features of the pattern are on the order of micrometers or nanometers.

In certain embodiments, the invention relates to any one of the aforementioned transformed composite materials, wherein the pattern is substantially present in an area from about 0.01 cm² to about 10 m². In certain embodiments, the pattern is substantially present in an area from about 0.1 cm² to about 1 m². In certain embodiments, the pattern is substantially present in an area from about 1 cm² to about 100 cm². In certain embodiments, the pattern is substantially present in an area greater than about 1 cm².

### Exemplary Articles

In certain embodiments, the invention relates to an article comprising any one of the aforementioned transformed composite materials.

In certain embodiments, the invention relates to any one of the aforementioned articles for the reversible dissipation of energy.

In certain embodiments, the invention relates to any one of the aforementioned articles, wherein the article comprises electro-active polymers, dielectric elastomeric composites, magneto-rheological elastomers with enhanced electro-mechanical, magneto-mechanical, dielectric and magnetic properties.

In certain embodiments, the invention relates to any one of the aforementioned articles, wherein the article is an artificial muscle.

In certain embodiments, the invention relates to any one of the aforementioned articles, wherein the article is a sensor.

In certain embodiments, the invention relates to any one of the aforementioned articles, wherein the article is a photonic or phononic crystal.

In certain embodiments, the invention relates to any one of the aforementioned articles, wherein the article is a phononic and photonic mirror or filter.

In certain embodiments, the invention relates to any one of the aforementioned articles, wherein the article is a waveguide.

In certain embodiments, the invention relates to any one of the aforementioned articles, wherein the article is a multi-layer reflector.

In certain embodiments, the invention relates to any one of the aforementioned articles, wherein the article comprises structural color, camouflage, or cloaking

### EXEMPLIFICATION

### Example 1

### 1.1 General Methods

a. Finite Element Simulations

The RVE of the layered composites were modeled using the Finite Element software ABAQUS. Periodic boundary conditions were used to capture the repeating network of these composites. A loading condition of uniaxial compression was used to generate the internal compression of the interface and consequently trigger the instability. Two solvers within ABAQUS were used in these finite element simulations: BUCKLE and STANDARD. First, the eigen-value problem was solved via ABAQUS/BUCKLE where critical strain (eigen-value) and the critical wavelength (the first eigen-mode) were estimated in the linear range. Second, the first eigen-mode was input as an initial geometric imperfection (the perturbed amplitude is 1% of the layer thickness) and then post-buckling analysis was performed using an implicit algorithm for the post-buckling process capturing both geometric and material nonlinearity.

Finite element simulations of models with imperfections of 1%˜20% thickness of the layer were conducted. When the initial geometry imperfection is less than 5% thickness of the layer, the critical buckling strain is not influenced by the imperfection. When the imperfection is larger than 5%, the critical strain will decrease when the amplitude of the imperfection increases.

b. Mechanical Experiments

Single- and multiple- layered samples were fabricated with the Objet Connex500 (at MIT), a 3D multi-material printer. Two base polymers were used in printing: an acrylic-based photo-polymer, VeroWhite (Shore 83D, Young's Modulus ˜200 MPa), and a rubbery material, TangoPlus (Shore 30A, Young's Modulus ˜0.85 MPa). The transparent matrix was printed in TangoPlus, and the interfacial layer was printed in VeroWhite and also as a mixture of the two base materials, a so called digital material (Shore 95A, Young's Modulus ˜16 MPa). Compression tests were performed using a Zwick Mechanical Tester for force-displacement measurements. All tests were quasi-static with a compression displacement rate of 0.1 mm/s giving a nominal engineering strain rate 0.0025/s. All samples fully recovered to their original undeformed configuration upon unloading.

### 1.2 Results

a. Single interface between two like materials

When the distance between layers is large, the shear term

$$( - \frac{t}{2} \frac{d {σ}_{sy}}{d x} )$$

in Eq. (2) can be neglected, and we derive the instability conditions for the onset of the wrinkling interface. If the system is pressure free, i.e., p=0, and the matrix on either side of the interface is the same E₀₁=E₀₂=E₀, and ν₀₁=ν₀₂=ν₀, then the coefficient c reduces to

$$C = \frac{4 π {E}_{0}}{( 3 - {v}_{0} ) ( 1 + {v}_{0} )} .$$

The critical strain ε_{cr} and the half wavelength λ_{cr}/t, as derived from Eq. (3a), show power law scaling with simply the stiffness ratio E₁/E₀ and with coefficients that are dependent on the Poisson ratio of the matrix ν₀:

$$\{ \begin{matrix}\frac{{σ}_{cr}}{{E}_{1}} = - {C}_{ɛ} ( {v}_{0} ) {( \frac{{E}_{1}}{{E}_{0}} )}^{- \frac{2}{3}} \\ \frac{{λ}_{cr}}{t} = {C}_{λ} ( {v}_{0} ) {( \frac{{E}_{1}}{{E}_{0}} )}^{\frac{1}{3}} ,\end{matrix} \qquad ( 3 a )$$

where, C_{ε} and C_{λ} are coefficients which only depend on the Poisson ratio of matrix, such that:
For plane stress:

$$\begin{matrix}{C}_{ɛ} ( {v}_{0} ) = {{( 3 )}^{\frac{2}{3}} [ ( 3 - {v}_{0} ) ( 1 + {v}_{0} ) ]}^{- \frac{2}{3}} = {2.08 [ ( 3 - {v}_{0} ) ( 1 + {v}_{0} ) ]}^{- \frac{2}{3}} & ( 3 b ) \\ {C}_{λ} ( {v}_{0} ) = {{π ( \frac{1}{3} )}^{\frac{1}{3}} [ ( 3 - {v}_{0} ) ( 1 + {v}_{0} ) ]}^{\frac{1}{3}} = {2.18 [ ( 3 - {v}_{0} ) ( 1 + {v}_{0} ) ]}^{\frac{1}{3}} . & ( 3 c )\end{matrix}$$

For plane strain:

$$\begin{matrix}{C}_{ɛ} ( {v}_{0} ) = {{( 3 )}^{\frac{2}{3}} [ \frac{( 3 - 4 {v}_{0} )}{{( 1 - {v}_{0} )}^{2}} ]}^{- \frac{2}{3}} = {2.08 [ \frac{( 3 - 4 {v}_{0} )}{{( 1 - {v}_{0} )}^{2}} ]}^{- \frac{2}{3}} & ( 3 d ) \\ {C}_{λ} ( {v}_{0} ) = {{π ( \frac{1}{3} )}^{\frac{1}{3}} [ \frac{( 3 - 4 {v}_{0} )}{{( 1 - {v}_{0} )}^{2}} ]}^{\frac{1}{3}} = {2.18 [ \frac{( 3 - 4 {v}_{0} )}{{( 1 - {v}_{0} )}^{2}} ]}^{\frac{1}{3}} . & ( 3 e )\end{matrix}$$

By eliminating the terms of E₁/E₀, Eqs. (3) yield that for both plane stress and plane strain:

$${ɛ}_{cr} = {C}_{ɛ} {{C}_{λ}^{2} ( \frac{{λ}_{cr}}{t} )}^{- 2} = - {{π}^{2} ( \frac{{λ}_{cr}}{t} )}^{- 2} or \frac{{λ}_{cr}}{t} = \frac{π}{\sqrt{{ɛ}_{cr}}} \qquad ( 4 )$$

which shows that the relation between the critical strain and non-dimensional wave length is independent of any material composition in the linear range.

When the onset of instability occurs at very small strain, the critical wavelength in Eqs. (3) is accurate. However, when the critical strain is large, the interface layer thickness has increased before buckling due to incompressibility and is given by

$$t = {t}_{0} {e}^{- \frac{{v}_{0}}{1 - {v}_{0}} {ɛ}_{cr}} ,$$

where t₀ is the initial thickness. Thus, the critical wavelength to initial thickness ratio is modified as a function of the stiffness ratio is modified to:

$$\frac{{λ}_{cr}}{{t}_{0}} = {e}^{[ \frac{{v}_{0}}{1 - {v}_{0}} {C}_{E} ( {v}_{0} ) {( \frac{{E}_{1}}{{E}_{0}} )}^{- \frac{2}{3}} ]} {C}_{λ} ( {v}_{0} ) {( \frac{{E}_{1}}{{E}_{0}} )}^{\frac{1}{3}} . \qquad ( 5 )$$

In the post-buckling process, when the compressive strain ε is increased beyond εcr, the post-buckling wavelength λ decreases below λ_{cr} (shown in Eq. (5)) due to the decrease in effective length of the interface. Assuming the overall contour length of the interface is preserved, the wavelength λ is then given by incompressibility:

λ(ε)=λ_{cr}e^{(-|ε-ε}^{_{cr}}^{|)}, (6)

and the post-buckling amplitude is related to the post-buckling wavelength and the overall strain as:

$$A ( ɛ ) = \frac{λ ( ɛ )}{π} \sqrt{\vert ɛ - {ɛ}_{cr} \vert} . \qquad ( 7 )$$

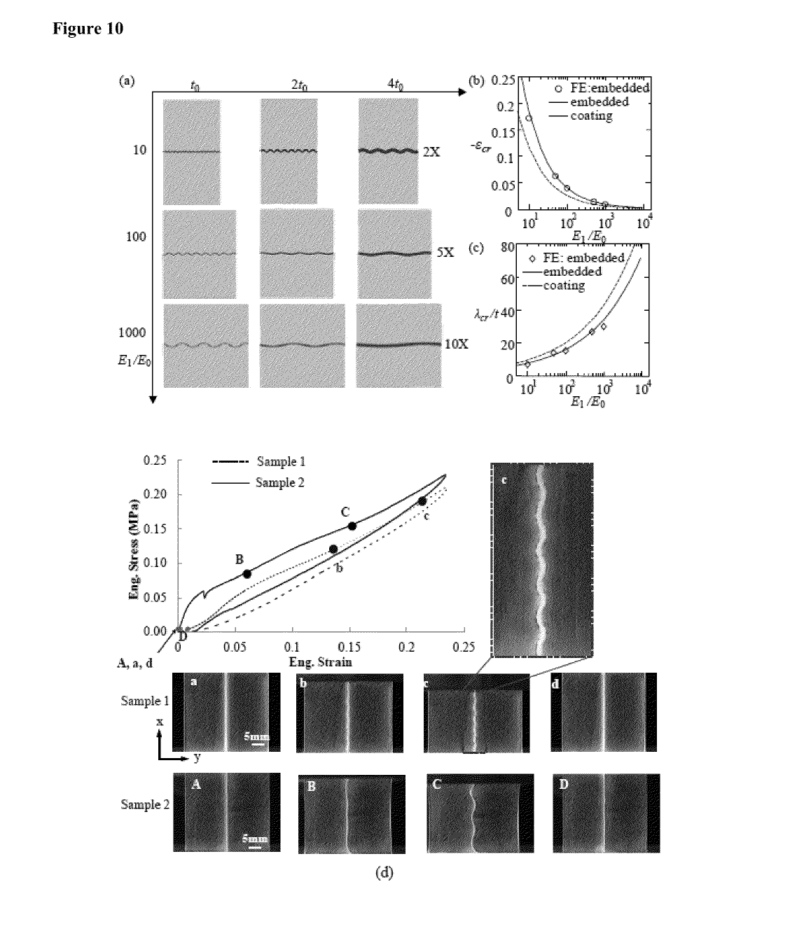

The results of the analytical derivations were further examined by comparison to finite element simulations. The structure (interfacial layer and the surrounding matrix) was modeled using 2D plane strain elements (ABAQUS, CPE8R) for both the interfacial layer and the matrix. The overall representative volume element (RVE) has a width of 1204t₀ (t₀ is the thickness of the interfacial layer simulated) and the length is integer times of the wavelength calculated from Eqs. (3) for each case. Interfacial layer of thickness t=t₀, 2t₀ and 4t₀ were modeled and evaluated, as shown in FIG. 4a. In the simulations, the loading conditions were uniaxial compression along the direction of the interfacial layer. Periodic boundary conditions were used in x and y direction to capture an infinitely long layer. Finite element simulation results of the wavy patterns of the beam are shown in FIG. 10a, in which the deformation were amplified by 2 or 5 times for visualization. It can be seen that the wavelength increases when the stiffness ratio increases and when the thickness increases. FIGS. 10(b) and 10(c) show that the new analytical model is accurate for a large range of stiffness ratios. The analytical results for the interfacial layer supported only on one side, representing the case of a coating on a compliant substrate was also included for the purpose of comparison.

Eqs. (3-7) were further verified by experiments of uni-axial compression of two samples containing a single interface layer. The in-plane dimension of both samples are 40 mm×40 mm, the out-of-plane dimension is 30 mm with interfacial thickness t₀=0.5 mm. The interfacial layer was printed as a digital material with full cured hardness of shore 95A for sample 1 and VeroWhite for sample 2. The matrix material is TangoPlus, which gives a stiffness ratio ˜20 for sample 1 and ˜200 for sample 2. The overall stress-strain curve and the snapshots of the sample at various overall strains are shown in FIG. 10d.

For sample 1, it can be seen that wrinkling initiates at b which has an overall strain about 0.14, as shown in FIG. 10d. This strain is quite close to 0.12, the critical strain predicted by Eqs. (3). The wrinkle amplitude increases as wavelength decreases from b and c as expected, as shown in FIG. 10d, and wave number kept unchanged. But the post-buckling wavelength decreases with the overall compressive strain, by using Eq. (6). Considering the overall deformation in the post-buckling process, at c, the wavelength is about 3.9 mm measured from the test, and the predicted wave length is about 4.2 mm using Eq. (5) and (6). Also, the post-buckling amplitude A=1.2 mm is predicted by Eq. (7), which is again very close to the experimental observation, as shown in FIG. 10d.

For sample 2, the critical strain predicted by Eqs. (3) is about 0.025. The wrinkle amplitude increases as wavelength decreases from B and C as expected, as shown in FIG. 10d, and the wave number kept unchanged. At C, the wavelength is about 13 mm measured from the test, and the predicted wave length is about 10 mm using Eqs. (3).

b. Single Interface between Two Different Materials

When the matrix materials on each side of the interfacial layer are different, the instability conditions for the onset of the wrinkling interface, i.e., the critical stress σ_{cr} and the resulting non-dimensional critical wavelength λ_{cr}/t are derived as a function of material composition:

for plane stress:

$$\{ \begin{matrix}\frac{{σ}_{cr}}{{E}_{1}} = {ɛ}_{cr} = {[ ( \frac{3}{2} ) \frac{{E}_{01} ( 3 - {v}_{02} ) ( 1 + {v}_{02} ) + {E}_{02} ( 3 - {v}_{01} ) ( 1 + {v}_{01} )}{{E}_{1} ( 3 - {v}_{01} ) ( 1 + {v}_{01} ) ( 3 - {v}_{02} ) ( 1 + {v}_{02} )} ]}^{\frac{2}{3}} \\ \frac{{λ}_{cr}}{t} = {2 [ ( \frac{{π}^{2}}{12} ) \frac{{E}_{1} ( 3 - {v}_{01} ) ( 1 + {v}_{01} ) ( 3 - {v}_{02} ) ( 1 + {v}_{02} )}{{E}_{01} ( 3 - {v}_{02} ) ( 1 + {v}_{02} ) + {E}_{02} ( 3 - {v}_{01} ) ( 1 + {v}_{01} )} ]}^{\frac{1}{3}} ;\end{matrix} \qquad ( 8 a )$$

for plane strain, by replacing: E₁, E₀₁, E₀₂ in Eq. (8a) by plane strain stiffnesses

$${\overline{E}}_{1} = \frac{{E}_{1}}{1 - {v}_{1}^{2}} , {\overline{E}}_{01} = \frac{{E}_{01}}{1 - {v}_{01}^{2}} , {\overline{E}}_{02} = \frac{{E}_{02}}{1 - {v}_{02}^{2}}$$

and also replacing ν₁, ν₀₁, ν₀₂ in Eq. (8a) by

$${\overline{v}}_{1} = \frac{{v}_{1}}{1 - {v}_{1}} , {\overline{v}}_{01} = \frac{{v}_{01}}{1 - {v}_{01}} , {\overline{v}}_{02} = \frac{{v}_{02}}{1 - {v}_{02}}$$

for plane strain state, solutions for plane strain are obtained:

$$\begin{matrix}\{ \begin{matrix}\frac{{σ}_{cr}}{{\overline{E}}_{1}} = {ɛ}_{cr} = {[ ( \frac{3}{2} ) \frac{{\overline{E}}_{01} ( 3 - 4 {v}_{02} ) {( 1 - {v}_{01} )}^{2} + {\overline{E}}_{02} ( 3 - 4 {v}_{01} ) {( 1 - {v}_{02} )}^{2}}{{\overline{E}}_{1} ( 3 - 4 {v}_{01} ) ( 3 - 4 {v}_{02} )} ]}^{\frac{3}{2}} \\ \frac{{λ}_{cr}}{t} = {2 [ ( \frac{{π}^{2}}{12} ) \frac{{\overline{E}}_{1} ( 3 - 4 {v}_{01} ) ( 3 - 4 {v}_{02} )}{{\overline{E}}_{01} ( 3 - 4 {v}_{02} ) {( 1 - {v}_{01} )}^{2} + {\overline{E}}_{02} ( 3 - 4 {v}_{01} ) {( 1 - {v}_{02} )}^{2}} ]}^{\frac{1}{3}} .\end{matrix} & ( 8 b )\end{matrix}$$

If ν₀₁=ν₀₂=ν₀, Eqs. (8a) and (8b) becomes

$$\{ \begin{matrix}\frac{{σ}_{cr}}{{E}_{1}} = {ɛ}_{cr} = {B}_{ɛ} ( {v}_{0} ) {( \frac{{E}_{1}}{{E}_{01} + {E}_{02}} )}^{- \frac{2}{3}} \\ \frac{{λ}_{cr}}{t} = {B}_{λ} ( {v}_{0} ) {( \frac{{E}_{1}}{{E}_{01} + {E}_{02}} )}^{\frac{1}{3}} ,\end{matrix} \qquad ( 8 c )$$

For plane stress:

$$\begin{matrix}{B}_{ɛ} ( {v}_{0} ) = {{( \frac{3}{2} )}^{\frac{2}{3}} [ ( 3 - {v}_{0} ) ( 1 + {v}_{0} ) ]}^{- \frac{2}{3}} = {1.31 [ ( 3 - {v}_{0} ) ( 1 + {v}_{0} ) ]}^{- \frac{2}{3}} & ( 8 d ) \\ {B}_{λ} ( {v}_{0} ) = {{π ( \frac{2}{3} )}^{\frac{1}{3}} [ ( 3 - {v}_{0} ) ( 1 + {v}_{0} ) ]}^{\frac{1}{3}} = {2.74 [ ( 3 - {v}_{0} ) ( 1 + {v}_{0} ) ]}^{\frac{1}{3}} . & ( 8 e ) \\ {B}_{ɛ} ( {v}_{0} ) = {{( \frac{3}{2} )}^{\frac{2}{3}} [ \frac{( 3 - 4 {v}_{0} )}{{( 1 - {v}_{0} )}^{2}} ]}^{- \frac{2}{3}} = {1.31 [ \frac{( 3 - 4 {v}_{0} )}{{( 1 + {v}_{0} )}^{2}} ]}^{- \frac{2}{3}} & ( 8 f ) \\ {B}_{λ} ( {v}_{0} ) = {{π ( \frac{2}{3} )}^{\frac{1}{3}} [ \frac{( 3 - 4 {v}_{0} )}{{( 1 - {v}_{0} )}^{2}} ]}^{\frac{1}{3}} = {2.74 [ \frac{( 3 - 4 {v}_{0} )}{{( 1 - {v}_{0} )}^{2}} ]}^{\frac{1}{3}} . & ( 8 g )\end{matrix}$$

For plane strain:

Since the shear term is neglected, the problem of a wrinkling interface can be analogous to that of the wrinkled thin coating layer on a substrate. If υ₀₁=υ₀₂=υ₀, Eq. (8b) shows the −⅔ power law scaling of ε_{cr} with E₁/(E₀₁+E₀₂) which agrees with the energy expression, and where the scaling coefficients only depend only on matrix properties and are now given in Eqs. (8d) and (8e) when the stress state is plane stress, and is given in Eqs. (8f) and (8g) when the stress state is plane strain. The critical wavelength λ_{cr} scales linearly with t and nonlinearly with E₁/(E₀₁+E₀₂). If we take E₀₂=0, and ν₀=½, Eqs.(8c), (8f) and (8g) give the classical solution for the wrinkling of thin film coated on a soft substrate.

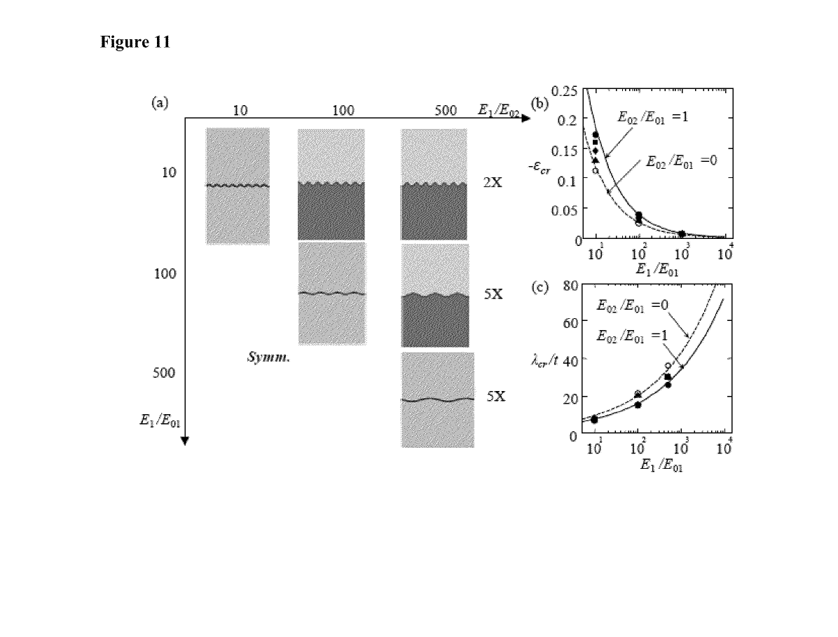

In addition, to further verify Eqs. (8b) (8c) (8f) and (8g) for plane strain, finite element simulations of an interfacial layer of t bonded on either side to two different matrix mediums are conducted for the case of and υ₀₁=υ₀₂=0.48, as shown in FIG. 11a. More general, if υ01≠υ02, Eq. (8b) shows that the critical strain and wavelength are related to two independent non-dimensional parameters E₁/E₀₁ and E₀₂/E₀₁. To make quantitative evaluation, E₁/E₀₁ is varied from 10˜1000, and E₀₂/E₀₁ is varied from 0˜1, as shown in FIGS. 11a, b and c.

FIG. 11 shows that the critical strain is mainly determined by E₁/E₀₁ (E₀₁>E₀₂). For a certain value of E₁/E₀₁, by adjusting E₀₂/E₀₁ from 0˜1 (E₀₂/E₀₁=0 corresponds to the case of coating, E₀₂/E₀₁=1 corresponds to the same matrix mediums on both sides), if υ₀₁=υ₀₂, the critical strain can be tuned by a factor of 1˜2^{2/3}, and the critical wavelength can be tuned by a factor of 1˜2_{-1/3}, as shown in FIGS. 11(b) and (c). It can be seen that the critical strain is mainly determined by the stiffness ratio E₁/E₀₁, but also can be further tuned by E₀₂/E₀₁, the influence of E₀₂/E₀₁ on the critical strain increases when E₁/E₀₁ increases, as shown in FIG. 11b, and that on the nondimensional critical wavelength increases when E₁/E₀₁ increases, as shown in FIG. 11c. The study on the dissimilar matrix layers around the interfacial layer builds a foundation to design functional graded materials.

c. Multi-Layered Composites

Eqs. (3a-3g) describe the characteristics of the wrinkling for multi-layered structures when the distance between two consecutive interface layers d is large. However, when the distance between the layers is small the stress fields in the matrix between the layers interact and must be included in the governing equation.

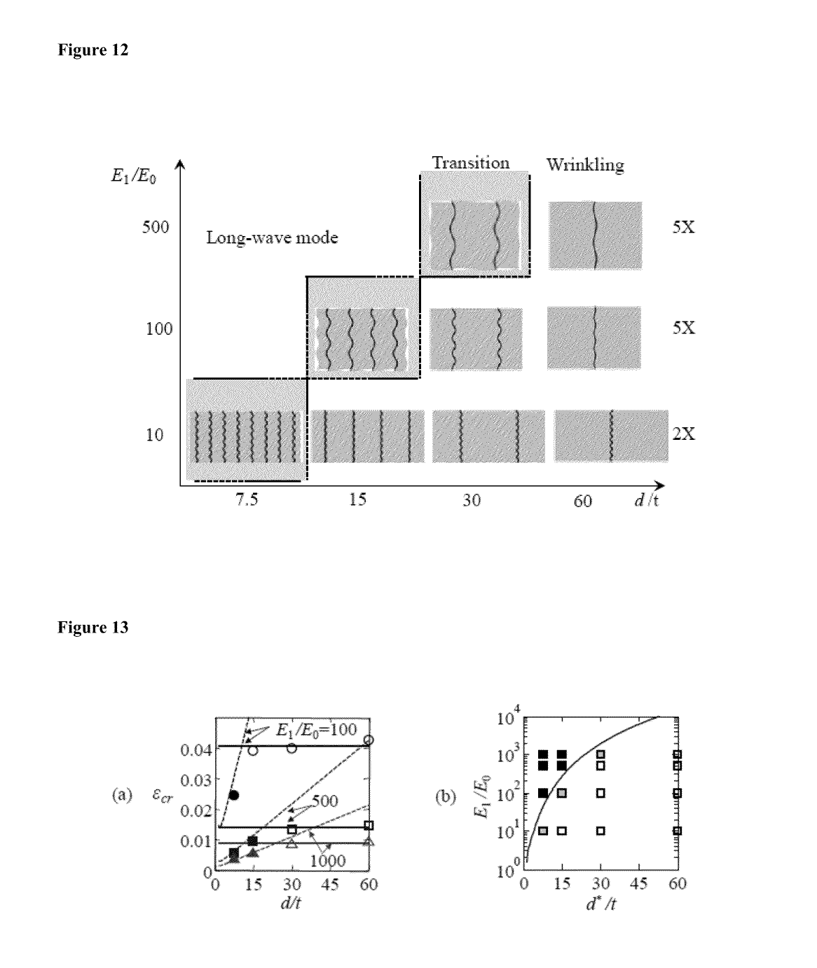

To evaluate the effects of layer distance, finite element simulations were carried out for multi-layers with uniform distance-to-thickness ratio d/t=60, 30, 15, and 7.5 with various stiffness ratios between the two phases, E₁/E₀. The post-buckling analyses showing the eigenmodes from the FE simulations are shown in FIG. 12. It can be seen that when the stiffness ratio increases and the distance between layers decreases, the instability configuration transits from a local wrinkling mode to a long-wave mode with infinite long wavelength. By focusing on the three cases across the transition zone, d/t=30, 15 and 7.5, for E₁/E₀=100, when d/t decreases and the wavelength increases, the normal stress in the matrix diminishes. Simultaneously, the shear stress in the matrix changes from a localized distribution to a uniform distribution for the long-wave modes. This implies that normal stresses are dominating for the wrinkling case, while long-wave modes are dominated by shear stresses, and in the transition zone, both normal stress and shear stress play important roles. The transition case reveals larger localized shear stress values and larger wave length (as shown in FIG. 12) then the local wrinkling cases, which are due to the interference between two neighboring layers.

The macro/global long-wave mode of a multi-layered composite where the two phases buckle together was derived by Rosen using the energy method and assuming a shear mode deformation. (Rosen, B. W. American Society for Metals 1965). Efforts were also made to find the more general solution taking account both terms of normal stress and shear stress in Eq. (1). The critical strain and critical d/t at which global mode occurs can be predicted by the approach of Rosen and can be written as:

$${ɛ}_{CT}^{Global} = \frac{1}{2 ( 1 + {v}_{0} )} \frac{{d}^{2}}{t ( d - t )} {( \frac{{E}_{1}}{{E}_{0}} )}^{- 1} . \qquad ( 9 )$$

By making Eq. (9) equals Eq. (4), the critical layer distance to thickness ratio d*/t at which the instability transitions from micro/local finite-wavelength mode to macro/global long-wavelength mode instability is derived as a function of the stiffness ratio and the Poisson ratio of the matrix:

$$\frac{{d}^{*}}{t} = {\{ 0.5 - \sqrt{0.25 - 0.24 {( 3 - {v}_{0} )}^{\frac{2}{3}} {( 1 + {v}_{0} )}^{- \frac{1}{3}} {( \frac{{E}_{1}}{{E}_{0}} )}^{- \frac{1}{3}}} \}}^{- 1} \qquad ( 10 )$$

The equations describing the characteristics for wrinkling and global long-wave mode, lead to a relationship between the critical buckling length λ_{cr} and the critical distance between the layers, d*:λ_{cr}*=0.52(3−ν₀)d*≈(¾)d*. This shows that if the distance between the layers d<1.25λ_{cr}, the neighboring layers start to interact and the shear stress contribution becomes significant such that a macro/global mode is observed.

Soft and reversible materials often exhibit smaller stiffness ratios between the stiffer and softer phases, which consequently decreases the critical distance necessary between the layers for wrinkling to arise. FIG. 13a shows that for smaller stiffness ratios only a very small interval of d/t will result in global modes of instability described by Eq. (9) and the rest will be explained by the wrinkling mechanics with characteristics described by Eqs. (3). The general transition between wrinkling and macro long-wave modes is shown in FIG. 13a, making this an efficient and useful graph for predicting the instability mode when designing new structures.

The critical layer distance-to-thickness ratio (Eq. 10) which separates wrinkling and global modes was plotted as a function of stiffness ratio in FIG. 13b (solid line). Here, the macroscopic bifurcations are associated with zero Bloch-wave number. Note that these large scale bifurcations can be identified with loss of positive definiteness of the homogenized acoustic tensor of the composite.

Post-bifurcation finite element simulations show that the critical strain of wrinkling modes is not sensitive to imperfection. However, when d is around 1.25λ_{cr} (in the transition zone) the system becomes very sensitive to initial imperfections and boundary conditions. An extension/symmetric/anti-phase mode (with period in y direction equaling d) different than the shear/asymmetric/in-phase mode (with period in the y direction equaling 2d) can be observed, as shown in FIG. 12ab, as well as mixed shear and extension modes (with period in y direction larger than 2d) can be triggered if the structure is tuned appropriately. This is because in the transition zone, all the different modes with different periodicity in the y direction correspond to very similar strain energy density, Such that the results become dependent and are determined by the initial imperfection and/or boundary conditions.

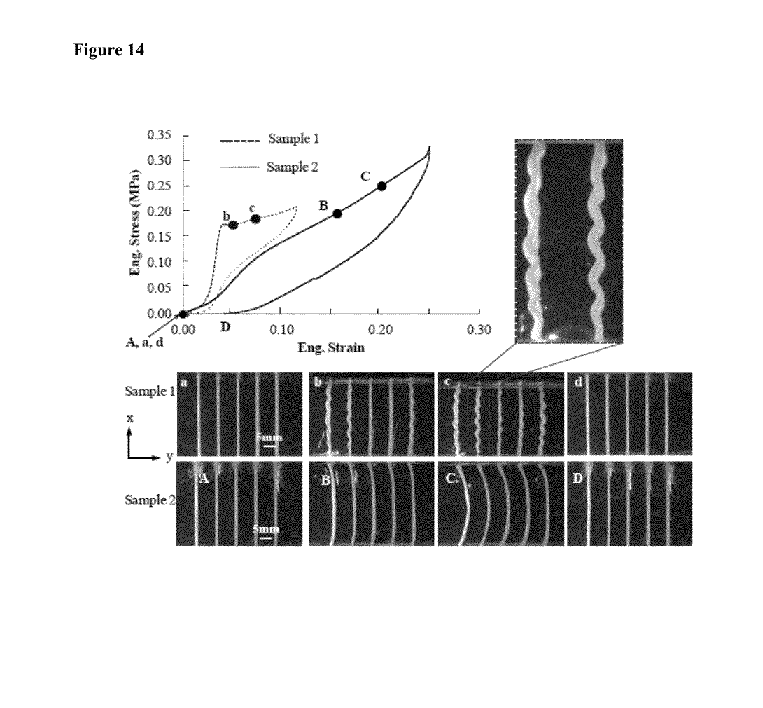

Again, mechanical tests on samples of multiple layered composites were performed. The sample 1 and sample 2 in FIG. 14 has a distance of 7.5 mm between layers. The interfacial layer thickness for both samples is 0.5 mm. The overall dimensions of the two samples are the same as the single-layered samples. The interfacial layer was printed as a digital material with full cured hardness of shore 95A for sample 1 and VeroWhite for sample 2. The matrix material is TangoPlus, which gives a stiffness ratio ˜20 for sample 1 and ˜200 for sample 2. Compression is along direction x. The overall stress-strain curve and the snapshots of the sample at various overall strains are shown in FIG. 14.

As shown in FIG. !4, Sample 1 has a layer distance larger than the critical distance predicted by Eq. (10), so a wrinkling occurs and there is little interaction between layers. Sample 2 has a layer distance a little smaller than the critical distance predicted by Eq. (10), so a long wave mode occurs and the layered structure response like a homogeneous material.

d. Hexagonal and Diamond-Shaped Cellular Components

Finite element models of hexagonal, diamond and rectangular cellular networks embedded in a soft matrix are built to study the instability of the cellular composites. Physically, hexagonal models can for example represent the scenario of isotropic epidermis cells under constrained growth where the cells are idealized as hexagonal network embedded in a soft matrix (the simulation only represents a snapshot state during cell growth, so the volume and mass gain can be neglected); or the case of a stiff network embedded in stimuli responsive hydrogels under compressive stresses.

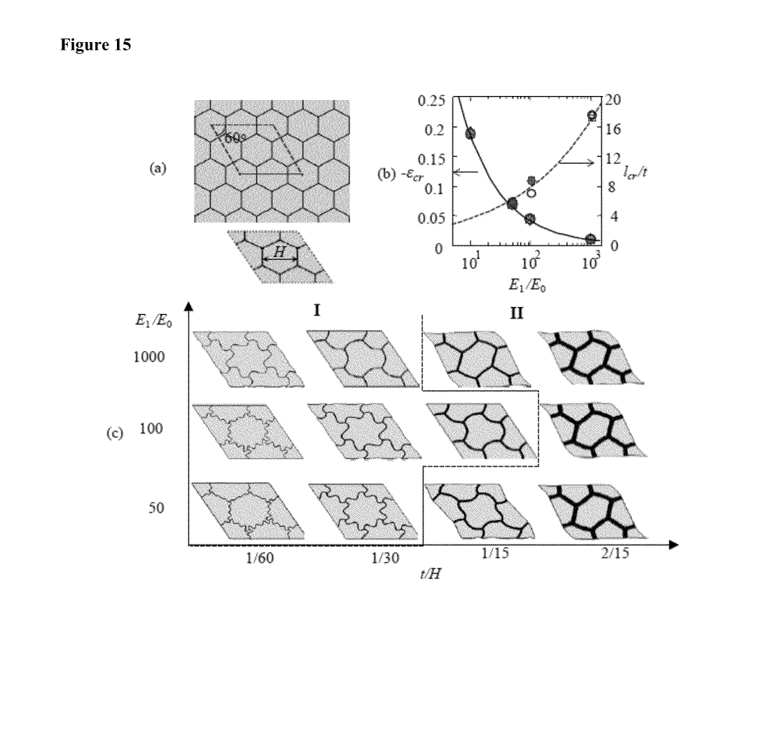

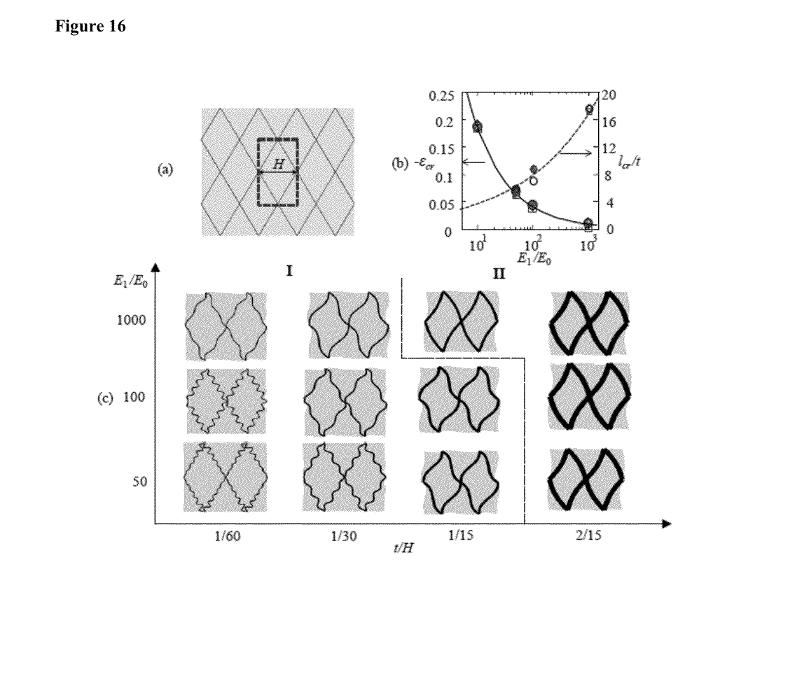

Equivalent bi-axial stresses are generated in the finite element models by using constrained expansion of the network. The materials are assumed to be linear elastic and isotropic. The networks are composed of regular hexagonal or diamond-shaped cells with a uniform size (the height between two parallel edges of a hexagon or the shortest distance between two vertices, H=30 μm, as shown in FIGS. 15a and 16a). A two-unit representative volume element (RVE) is set up in ABAQUS, and FE simulations are processed by varying wall thickness of the network t=0.5, 1, 2, and 4 μm, for the stiffness ratio of E₁/E₀=50, 100, and 1000. To simulate the net growth of the cells, the vertexes of the RVE are pinned and periodic boundary conditions are applied. The RVE is under constrained linear expansion; the matrix is under isotropic expansion with the expansion coefficient α=1, while the network expand with the same expansion coefficient but only along its own direction. Thus, the RVE is under bi-axial compression. The network is not only constrained by the matrix, but is also subjected to transverse compressive stress due to the expansion of the matrix, which is equivalent to the pressure term in Eqs. (2) with p˜αE₀T_{cr}. However, since the stiffness ratio is large in our analyses, this p term in Eq. (2) from the matrix expansion is still negligible.

The FE results of the critical eigenmodes for various geometry and material composition (t/H and E₁/E₀) are shown in FIGS. 15a, b and c. and FIGS. 16a. b and c. Due to the isotropic geometry of the model, the wave numbers of each segment of the network are the same for all parameters. Thus, the instability characteristics of the system, the equivalent critical strain ε_{cr}=αT, (T_{cr} is the eigenvalue corresponding to the lowest eigenmode) and the non-dimensional half wavelength l_{cr}/t of the edges of each cell, are compared with the prediction of the present analytical model (Eqs. (3a-3g), as shown in FIGS. 15b and 16b. It can be seen that the critical strains are predicted very accurately, and the wavelength is also very accurate when the wave number of each edge is large. However, the wavelength from FE simulation can only give the lower limit of the real wavelength when the wave number is less than one. Also, the influence of the finite length needs to be considered in the analytical model.

FIGS. 15 and 16 show that when the stiffness ratio E₁/E₀ and thickness to cell size ratio t/H decreases, the matrix plays an important role in resisting network segments to buckle in long wavelength. Also, from a post-bifurcation analysis, it was seen that the system becomes increasingly more sensitive to the initial imperfection when E₁/E₀ and t/H decreases. For example, due to a light asymmetry in the mesh, little asymmetry is also obtained in the results for the case of E₁/E₀=50 and t/H=1.67 (the lower left corner shown in FIGS. 15c and 16c). However, by taking the hexagonal cellular composite as an example, when the stiffness ratio E₁/E₀ and thickness to cell size ratio t/H increases, the influences of matrix diminish and the results are asymptotic to the classical results of hexagonal honeycomb under bi-axial compression. A uniform flower mode is achieved, which was also observed and analyzed in circular honeycomb under in-plane compression, and the rubber structure with circular and elliptic pores.

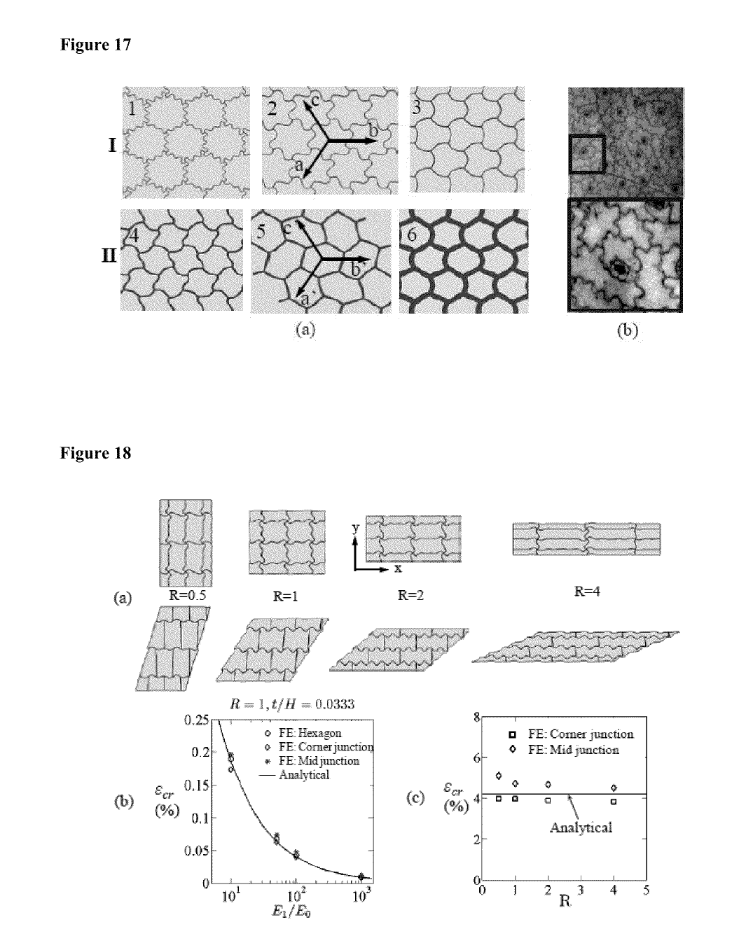

Based on group-theoretic bifurcation theory, an exhausted categorization of honeycomb without matrix was proposed. Considering the broad range of engineering applications, the undulation patterns calculated from the parametric study are categorized in two main types: type I) local repeating patterns, type II) global alternating patterns, as shown in FIG. 17(a). These two types of patterns were also indicated in the parameter space, as shown in the phase diagram in FIG. 15c. A Type I pattern is defined as the pattern of a single cell that repeats itself in all three axes of symmetry, thus the local pattern of one cell can represent the overall pattern. Type II pattern is defined as one or several cell patterns alternating along one or multi axes of symmetry. FIG. 17a illustrates examples of Type II patterns: image 4 has one cell pattern repeating along the b′ axis and two cell patterns alternating in the a′ and c′ axes, image 5 has two cell patterns alternating in all three axes, and pattern 6 has three cell patterns alternating in all three axes. This definition can be extended to a system with n axes of symmetry.

Usually, for a uniform matrix and network, the type II pattern is characterized by a segment wavelength less or equal to half intrinsic wavelength and the type I patterns are dominated by multi-wave patterns. It can be seen that the boundary of the RVEs (FIGS. 15c and 16c) for the type I patterns are straight, while the boundary of those of type II patterns shows a wavelength. This indicated that the composites with type I patterns has a smaller intrinsic material length scale than the type II patterns. However, when the uniform system with a type I pattern is disturbed by a patterned heterogeneity in a larger scale, type II pattern can also be triggered and then a mixed-type of patterns can be formed. This may explain the undulation pattern of the epidermis cells around guard cells, as shown in FIG. 17b (lower). The guard cells works as a heterogeneity pattern in a larger scale, and therefore a mixed-type pattern (similar to pattern1+pattern 5 in FIG. 17a) can be observed around a guard cell in the sense that the cell both undulates itself and alternates with other cells.

e. Rectangular and Brick-Shaped Cellular Components

To understand how the cell morphology influences the instability of the system, different FE models are evaluated in ABAQUS, as shown in FIG. 18a. The eight different models can be divided into two groups: i) an assembly of rectangular cells with corner junctions, and ii) an assembly of rectangular cells with mid junctions. The length aspect ratio of each rectangular cell is defined as the ratio R=Lₓ/L_{y}, where Lᵢ is the cell length in the i-direction (x-direction is defined as the direction when the segments are continuous for any assembly). The cases of R=0.5, 1, 2 and 4 are considered and compared in this study. To rule out the influence of cell size, the area of each cell in all models is kept constant (30 μm×30 μm). Furthermore, a network thickness of t=1 μm and stiffness ratio of E₁/E₀=100 are kept fixed for all the FE simulations. We will focus on type I patterns in this section.

The numerical results of the instability characteristics are shown in FIG. 18. It can be seen in FIG. 18b that the analytical model is again very accurate in predicting the critical strain for all shapes and cell assemblies under consideration. The critical strains of square assemblies with corner junctions are slightly larger than strains of that with mid junctions and the hexagonal cells assemblies considered earlier in this paper. As shown in FIG. 18c, the influence of length aspect ratio R has only little influence on the critical strain, especially when R>1. Here, and the critical strain of the cells with mid junctions are slightly larger than the analytical predictions, whereas the critical strain of the normal assemblies are slightly lower than the analytical predictions. The main influence of the assembly lies in the instability modes. As shown in FIG. 18a, for all R values, the deformation of cells with corner junctions is localized in these junctions which other part of the interfacial segments keep almost straight, and this type of localization becomes more severe when R increases. However, the deformation of the cells with mid junctions is distributed nicely along the longer segments via the uniform wavelength. For the hexagonal network, the cells are with tri junctions which have the similar function as the mid junctions. This trend can also be observed in plant epidermis cells that show various morphologies. Some plant cells are quasi isotropic with similar length in all directions, such as the epidermis cells of Arabidopsis thaliana, and seed coat of Viscaria vulgaris and Portulaca orleracea, while others are very anisotropic with a preferential elongation in one direction, such as the long leaf epidermis cells of Panicum javanicum and the palea of Foxtail millet. The results in this study can provide insight into the morphogenesis of plant epidermis cells.

### INCORPORATION BY REFERENCE

All of the U.S. patents and U.S. patent application publications cited herein are hereby incorporated by reference.

### Equivalents

Those skilled in the art will recognize, or be able to ascertain using no more than routine experimentation, many equivalents to the specific embodiments of the invention described herein. Such equivalents are intended to be encompassed by the following claims.

We claim:

1. A method, comprising the steps of:
providing a first material and a second material;
contacting the first material with the second material to form a composite material with a material interface;
applying a first force to the composite material, wherein the first force is calculated to produce a desired transformation in the morphology of the material interface, and the first force produces the desired transformation in the morphology of the material interface, thereby forming a transformed composite material.

2. The method of claim 1, wherein the first force is a load or deformation condition.

3. The method of claim 1, wherein the first force is stretch or strain.

4. The method of claim 1, wherein the force is stretch or strain; and the force is applied substantially in-plane with the material interface.

5. The method of claim 1, wherein the first force is applied directly or indirectly to the composite material.

6. The method of claim 1, wherein the first force is constrained swelling.

7. The method of claim 1, wherein the first force is thermal expansion.

8. The method of claim 1, wherein the first force is phase transformation.

9. The method of claim 1, wherein the material interface is transformed from being substantially straight to having a wavy pattern.

10. The method of claim 1, wherein the wavelength or the amplitude of the material interface is transformed.

11. The method of claim 1, further comprising the step of removing the first force from the composite material.

12. The method of claim 1, wherein the first material or the second material is an elastomer.

13. The method of claim 1, wherein the first material or the second material is an elasto-plastic.

14. The method of claim 1, wherein the first material or the second material is a polymer or an alloy.

15. The method of claim 1, wherein the first material or the second material is a hydrogel.

16. The method of claim 1, wherein the first material or the second material is a stimuli-responsive polymer.

17. The method of claim 1, wherein the first material or the second material is an electroactive polymer.

18. The method of claim 1, wherein the first material or the second material is porous.

19. The method of claim 1, wherein the first material or the second material comprises cells.

20. A transformed composite material made by a method of claim 1.

21. An article comprising a transformed composite material of claim 20.
